(19) United States
(12) Patent Application Publication
(10) Pub. No.: US 2024/0012688 A1
(43) Pub. Date: Jan. 11, 2024

(54) INFORMATION PROCESSING SYSTEM, INFORMATION PROCESSING DEVICE, AND DETERMINATION METHOD

(71) Applicant: Fujitsu Limited, Kawasaki-shi (JP)

(72) Inventor: Kazuya UNO, Yokohama (JP)

(73) Assignee: Fujitsu Limited, Kawasaki-shi (JP)

(21) Appl. No.: 18/301,844

(22) Filed: Apr. 17, 2023

(30) Foreign Application Priority Data
Jul. 11, 2022 (JP) 2022-111457

(51) Int. Cl. G06F 9/50

(52) U.S. Cl. CPC G06F 9/5044

(57) ABSTRACT

An information processing system includes: a first device including a first processor; and a second device including a second processor communicable with the first device. The first processor refers to a memory that stores an attribute group related to the second device in association with each type of a procedure, and specifies a first attribute group corresponding to a type of a target procedure to be performed for the second device, transmits a transmission request of each attribute value of the specified first attribute group to the second device, and determines whether or not to perform the target procedure based on the each attribute value of one or more attributes included in the first attribute group received from the second device in response to the transmission request.

### CROSS-REFERENCE TO RELATED APPLICATION

This application is based upon and claims the benefit of priority of the prior Japanese Patent Application No. 2022-111457, filed on Jul. 11, 2022, the entire contents of which are incorporated herein by reference.

### FIELD

The embodiment discussed herein is related to an information processing system, an information processing device, and a determination method.

### BACKGROUND

Conventionally, there is a technique in which an administrator of a server is examined by a certificate authority and obtains a server certificate, and sets the server certificate in the server, so that a user of a terminal device coupled to the server is allowed to confirm the server certificate and evaluate reliability of the server. The server certificate is, for example, a secure socket layer (SSL) certificate. An SSL certificate contains basic information regarding the server, such as an organization name, for example.

U.S. Patent Application Publication No. 2018/0109537 is disclosed as related art.

### SUMMARY

According to an aspect of the embodiments, an information processing system includes: a first device including a first processor; and a second device including a second processor communicable with the first device. The first processor refers to a memory that stores an attribute group related to the second device in association with each type of a procedure, and specifies a first attribute group corresponding to a type of a target procedure to be performed for the second device, transmits a transmission request of each attribute value of the specified first attribute group to the second device, and determines whether or not to perform the target procedure based on the each attribute value of one or more attributes included in the first attribute group received from the second device in response to the transmission request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 201;

FIG. 4 is an explanatory table illustrating an example of content stored in an attribute-related information management table 400;

FIG. 5 is an explanatory table illustrating an example of content stored in a level information management table 500;

FIG. 6 is a block diagram illustrating an example of a functional configuration of the information processing device 201;

FIG. 7 is a block diagram illustrating a specific example of the functional configuration of the information processing device 201;

FIG. 8 is an explanatory diagram (part 1) illustrating an operation example of the information processing device 201;

FIG. 9 is an explanatory diagram (part 2) illustrating an operation example of the information processing device 201;

FIG. 10 is an explanatory diagram (part 3) illustrating an operation example of the information processing device 201;

FIG. 11 is an explanatory diagram (part 4) illustrating an operation example of the information processing device 201;

FIG. 12 is an explanatory diagram (part 5) illustrating an operation example of the information processing device 201;

FIG. 13 is a flowchart (part 1) illustrating an example of a determination processing procedure;

FIG. 14 is a flowchart (part 2) illustrating an example of the determination processing procedure;

FIG. 15 is a flowchart (part 3) illustrating an example of the determination processing procedure; and

FIG. 16 is a flowchart (part 4) illustrating an example of the determination processing procedure.

### DESCRIPTION OF EMBODIMENTS

An existing technique allows a requesting-side entity to execute an action in a case where a trust level between the requesting entity and a target entity exceeds a trust threshold level, for example.

However, it is sometimes difficult to accurately evaluate the reliability of the server with the existing technique. For example, the SSL certificates do not contain detailed information other than the basic information, the detailed information being useful when evaluating the reliability of the server, making it difficult to accurately evaluate the reliability of the server.

In one aspect, an object of the present embodiment is to facilitate evaluation of the reliability of a target.

Hereinafter, an embodiment of an information processing system, an information processing device, and a determination method will be described in detail with reference to the drawings.

(Example of Information Processing Method According to Embodiment)

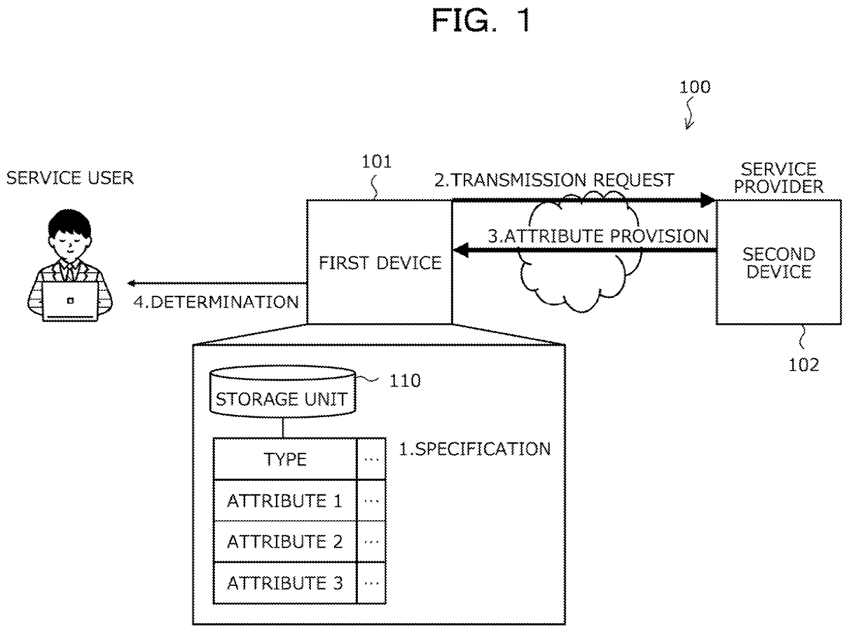

FIG. 1 is an explanatory diagram illustrating an example of an information processing method according to an embodiment. A first device 101 is a computer for facilitating evaluation of reliability of a target. The first device 101 is, for example, a server, a personal computer (PC), or the like.

The target is, for example, a computer of a party Y who communicates with a party X. The computer is, for example, a server, a PC, or the like. The communication is, for example, service use or the like. The service includes, for example, browsing of explanatory information of goods on a web page, sales contracts for goods, or the like.

The party X is, for example, an individual or an organization. The party X is, for example, a service user. The party X is, for example, a purchaser of goods in a transaction. The party Y is, for example, an individual or an organization. The party Y is, for example, a service provider. The party Y is, for example, a supplier of the goods in the transaction. For example, the party Y may be treated as the target.

Here, it may be desired to evaluate the reliability of the target. In recent years, there has been an increasing tendency for the parties X and Y to communicate online instead of face-to-face. For this reason, it may be desired to enable the party X to evaluate the reliability of the party Y online rather than face-to-face.

For example, to avoid a fraudulent behavior of the party Y with bad faith, or to avoid a trouble that the party Y does not have a level of competence that the party X expects, it is desirable to enable the party X to evaluate the reliability of the party Y. For example, the party X wishes to evaluate the reliability of the party Y before conducting transactions with the party Y online.

For the evaluation, there is a method that enables evaluation of the reliability of the target using a server certificate. The server certificate is, for example, an SSL certificate. For example, it is conceivable that the party Y is examined by a certificate authority, obtains the server certificate, and sets the server certificate in the server, and the party X confirms the server certificate, thereby enabling evaluation of the reliability of the server and enabling evaluation of the reliability of the party Y. The server certificate includes, for example, basic information regarding the server. The basic information is, for example, an organization name of the party Y who owns the server, or the like.

However, it may be difficult to accurately evaluate the reliability of the target with the above method. For example, the party X may find it difficult to accurately evaluate the reliability of the server or the party Y, and may not be able to properly determine whether or not to conduct a transaction with the party Y.

For example, the server certificate does not include, besides the basic information, detailed information useful in evaluating the reliability of the server. The detailed information may include, for example, verifiable credentials (VC). The detailed information may include, for example, electronic corporate registration records. The detailed information may include, for example, electronic passport information. The detailed information may include, for example, official authentication information.

Therefore, the party X is not able to refer to the detailed information even if the party X obtains the server certificate. Therefore, the party X may find it difficult to accurately evaluate the reliability of the server or the party Y, and may not be able to properly determine whether or not to conduct a transaction with the party Y.

Here, a method is conceivable in which the party Y discloses the detailed information together with the server certificate to the party X, and the party X uses the detailed information together with the server certificate to accurately evaluate the reliability of the target. Even with this method, it may be difficult for the party X to accurately evaluate the reliability of the server or the party Y.

For example, the party X may wish to refer to the detailed information of desired content in order to evaluate the reliability of the party Y. The desired content is that, for example, the detailed information includes desired authentication information. At this time, if the party Y does not have the desired authentication information, the party Y is not able to disclose the detailed information to the party X until the party Y obtains the desired authentication information.

Therefore, a time required for the party Y to disclose the detailed information to the party X increases. Then, a time required for the party X to accurately evaluate the reliability of the server or the party Y by referring to the detailed information including the desired authentication information increases. As a result, the party X is not able to quickly determine whether or not to conduct a transaction with the party Y.

By the way, the type of information that the party X wants to refer to in evaluating the reliability of the party Y may differ depending on the type of communication between the party X and the party Y. The party X wants to refer to the basic information regarding the server in a case of viewing explanatory information of the goods, for example. For example, the party X wants to refer to the detailed information regarding the server in addition to the basic information regarding the server in a case of making a sales contract for goods.

Conventionally, the party X is not able to change the type of information requested to the party Y to disclose according to the type of communication between the party X and the party Y. Furthermore, the party Y is not able to change the type of information to be disclosed to the party X according to the type of communication between the party X and the party Y. For this reason, it is difficult for the party X to refer to only appropriate information according to the type of communication between the party X and the party Y, and it may be difficult for the party X to accurately and efficiently evaluate the reliability of the server or the party Y.

Therefore, in the present embodiment, an information processing method capable of facilitating evaluation of the reliability of the target will be described.

In FIG. 1, an information processing system 100 includes a first device 101 and a second device 102 capable of communicating with the first device 101. The second device 102 is, for example, a server that provides shopping services. The second device 102 provides, for example, the first device 101 with a service for browsing web pages. The web page contains explanatory information of goods. The second device 102 provides, for example, the first device 101 with a service of purchasing goods and making a payment.

The first device 101 has a storage unit 110. The storage unit 110 stores an attribute group related to the second device 102 in association with each type of procedure. The procedure is performed for the second device 102, for example. The procedure is, for example, browsing a web page and downloading a file such as a video or a still image of the web page, or browsing a web page, referring to the explanatory information of goods, purchasing the goods and making a payment, or the like.

In the following description, the type of the procedure of browsing a web page and downloading a file such as a video or a still image of the web page may be referred to as “browse”. Furthermore, the type of the procedure of browsing a web page, referring to the explanatory information of goods, purchasing the goods and making a payment may be referred to as “purchase”.

The attribute group related to the second device 102 may include attributes of an owner of the second device 102, for example. The attribute is, for example, nationality of the owner of the second device 102. The attribute is, for example, an organization name of the owner of the second device 102. The attribute is, for example, a group to which the owner of the second device 102 belongs. The attribute is, for example, privacy policy of the owner of the second device 102. The attribute is, for example, reputation information of the owner of the second device 102.

(1-1) The first device 101 refers to the storage unit 110 and specifies a first attribute group corresponding to the type of the target procedure to be performed for the second device 102. The first device 101 accepts designation of the type of the target procedure, refers to the storage unit 110, and specifies the first attribute group corresponding to the type of the target procedure for which the designation has been accepted, for example. This allows the first device 101 to specify what attribute value is useful when evaluating the reliability of the second device 102.

(1-2) The first device 101 transmits a transmission request for each attribute value of the specified first attribute group to the second device 102. The first device 101 generates, for example, the transmission request indicating each attribute type of the specified first attribute group and transmits the transmission request to the second device 102. This allows the first device 101 to request the second device 102 to disclose each attribute value of the first attribute group useful in evaluating the reliability of the second device 102.

(1-3) The second device 102 transmits each attribute value of one or more attributes included in the first attribute group to the first device 101 in response to the transmission request. The second device 102 may transmit any attribute value included in the first attribute group to the first device 101 and does not have to transmit the other attribute values to the first device 101 in response to the transmission request, for example.

The first device 101 determines whether or not to perform the target procedure based on each attribute value of the one or more attributes included in the first attribute group received from a communication destination device in response to the transmission request. Here, the determination to perform the target procedure corresponds to, for example, evaluation that the second device 102 is reliable. The determination not to perform the target procedure corresponds to, for example, evaluation that the second device 102 is not reliable.

The first device 101 specifies, for example, a score indicating the reliability of the second device 102, the score corresponding to each attribute value of the one or more attributes included in the first attribute group received from the communication destination device in response to the transmission request. The first device 101 determines to perform the target procedure in a case where the total score obtained by adding the specified scores is equal to or greater than a first threshold, and determines not to perform the target procedure in a case where the total score is less than the first threshold.

This allows the first device 101 to change the number of attributes and the attribute types to be used when evaluating the reliability of the second device 102 in accordance with the type of the target procedure. Therefore, the first device 101 can accurately evaluate the reliability of the second device 102 and accurately determine whether or not to perform the target procedure. Furthermore, the first device 101 can reduce a processing load and a processing time taken when determining whether or not to perform the target procedure.

For example, in a case where the target procedure is a procedure not involving money transactions with a relatively low risk, the first device 101 can reduce the number of attributes to be used in evaluating the reliability of the second device 102 to be relatively small. Therefore, the first device 101 can reduce the processing load, the processing time, and the like taken for the first device 101 and the second device 102 when determining whether or not to perform the target procedure.

For example, in a case where the target procedure is a procedure involving money transactions with a relatively large risk, the first device 101 can increase the number of attributes to be used in evaluating the reliability of the second device 102 to be relatively large. Therefore, the first device 101 can accurately evaluate the reliability of the second device 102 and accurately determine whether or not to perform the target procedure.

(1-4) The first device 101 outputs a determined result. Thereby, the first device 101 enables the user to refer to the determined result. The first device 101 can ensure the user's sense of security when performing the target procedure. In the case of determining to perform the target procedure, the first device 101 performs the target procedure for the second device 102. Thereby, the first device 101 enables the user to use the service of the second device 102.

Here, a case in which the storage unit 110 stores the attribute group related to the second device 102 in association with each type of procedure has been described, but the present embodiment is not limited to this. For example, there may be a case where there is only one procedure that can be the target procedure. In this case, the storage unit 110 stores the target procedure and the attribute group related to the second device 102 in association with each other. The first device 101 refers to the storage unit 110 and specifies the first attribute group corresponding to the type of a fixed target procedure.

Here, a case in which the first device 101 operates independently has been described, but the present embodiment is not limited to this. For example, there may be a case where the first device 101 cooperates with another computer. For example, there may be a case in which a plurality of computers implements a function as the first device 101. For example, the function as the first device 101 may be implemented on the cloud.

(Example of Information Processing System 200)

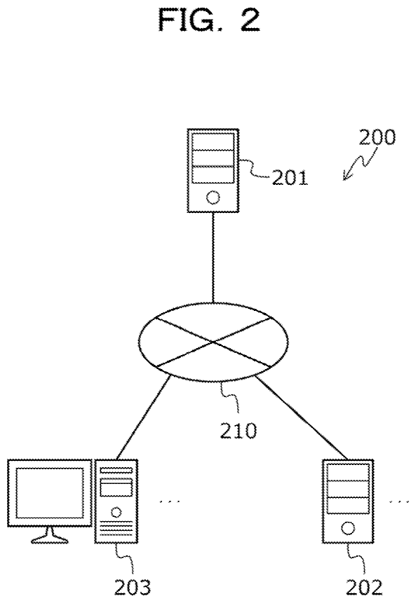

Next, an example of an information processing system 200 to which the first device 101 and the second device 102 illustrated in FIG. 1 are applied will be described with reference to FIG. 2.

FIG. 2 is an explanatory diagram illustrating an example of the information processing system 200. In FIG. 2, the information processing system 200 includes an information processing device 201, a server device 202, and a client device 203.

In the information processing system 200, the information processing device 201 and the server device 202 are coupled via a wired or wireless network 210. The network 210 is, for example, a local area network (LAN), a wide area network (WAN), the Internet, or the like. Furthermore, in the information processing system 200, the information processing device 201 and the client devices 203 are coupled via the wired or wireless network 210.

The information processing device 201 is a computer corresponding to the first device 101 illustrated in FIG. 1. The information processing device 201 can communicate with the server device 202. The information processing device 201 is capable of communicating with the client device 203. The information processing device 201 receives, from the client device 203, a coupling request to the server device 202 including a purpose of using a predetermined service provided by the server device 202. The purpose represents, for example, the type of the procedure to be performed for the server device 202.

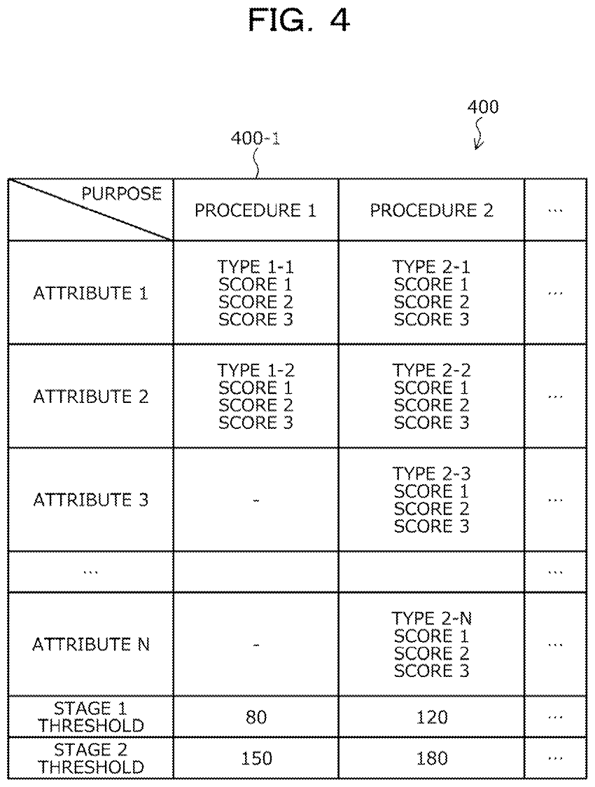

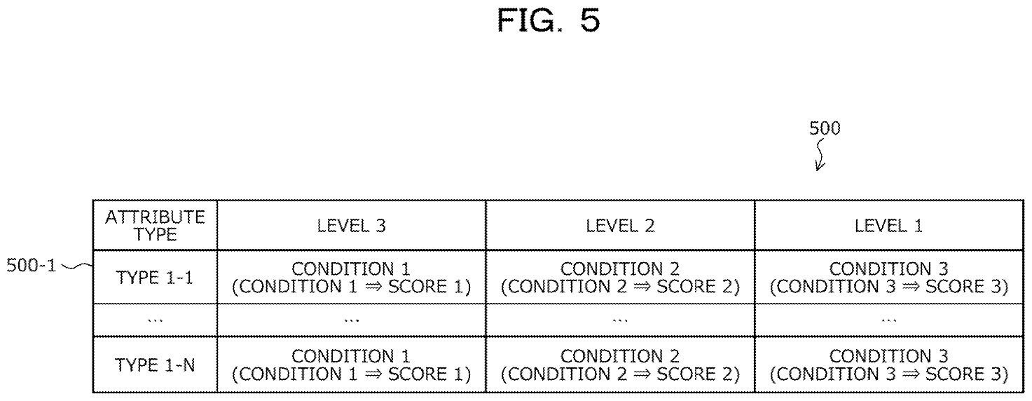

The information processing device 201 stores the attribute group related to the server device 202 in association with each type of procedure. The information processing device 201 stores, for example, an attribute-related information management table 400, which will be described below with reference to FIG. 4. The information processing device 201 stores, for each attribute related to the server device 202, information that enables specification of the score indicating the reliability of the server device 202, the score corresponding to the value of the attribute. The information processing device 201 stores, for example, a level information management table 500, which will be described below with reference to FIG. 5.

The information processing device 201 sets the procedure represented by the purpose of using a predetermined service as the target procedure based on the coupling request. The target procedure may include, for example, a plurality of pieces of processing. Here, it is assumed that the target procedure includes, for example, first processing and second processing. The information processing device 201 refers to the attribute-related information management table 400, which will be described below with reference to FIG. 4, and specifies the first attribute group corresponding to the type of the target procedure. The information processing device 201 determines whether or not to perform each processing that forms the target procedure based on the first attribute group.

The information processing device 201 transmits, to the server device 202, a first attribute request message that requests each attribute value of the specified first attribute group, for example. The information processing device 201 receives, from the server device 202, a first attribute disclosure message that indicates each attribute value included in one or more attributes of the first attribute group, for example.

The information processing device 201 refers to the level information management table 500, which will be described below with reference to FIG. 5, for example, and determines whether or not to perform the first processing and the second processing based on each attribute value included in the one or more attributes of the first attribute group indicated by the first attribute disclosure message.

The information processing device 201 permits the client device 203 to perform the target procedure for the server device 202 based on the determination result. The information processing device 201 controls the server device 202 and the client device 203 to enable the service user to use the predetermined service provided by the server device 202.

For example, in a case of determining to perform the first processing, the information processing device 201 permits the client device 203 to perform the first processing for the server device 202. For example, in a case of determining not to perform the first processing, the information processing device 201 may transmit an alert indicating absence of the reliability of the server device 202 to the client device 203. For example, in a case of determining to perform the second processing, the information processing device 201 permits the client device 203 to perform the second processing for the server device 202.

For example, in a case of determining to perform the first processing but not to perform the second processing, the information processing device 201 specifies a second attribute group related to the server device 202 when the client device 203 starts the first processing for the server device 202. The second attribute group may be included in the first attribute group, for example. The information processing device 201 transmits, to the server device 202, a second attribute request message that requests each attribute value of the specified second attribute group, for example.

The information processing device 201 receives, from the server device 202, a second attribute disclosure message that indicates each attribute value included in one or more attributes of the second attribute group, for example. The information processing device 201 refers to the level information management table 500, which will be described below with reference to FIG. 5, for example, and again determines whether or not to perform the second processing of forming the target procedure based on each attribute value included in the one or more attributes of the second attribute group indicated by the second attribute disclosure message.

The information processing device 201 permits the client device 203 to perform the target procedure for the server device 202 based on the determination result. The information processing device 201 controls the server device 202 and the client device 203 to enable the service user to use the predetermined service provided by the server device 202.

For example, in the case of determining to perform the second processing, the information processing device 201 permits the client device 203 to perform the second processing for the server device 202. For example, in the case of determining not to perform the second processing, the information processing device 201 may transmit an alert indicating absence of the reliability of the server device 202 to the client device 203. The information processing device 201 is, for example, a server, a PC, or the like.

The server device 202 is a computer corresponding to the second device 102 illustrated in FIG. 1. The server device 202 is used by a service provider who provides the predetermined service. The server device 202 provides the predetermined service to the service user who uses services. The server device 202 provides the predetermined service to the service user via the client device 203 coupled to the local device, for example.

The server device 202 receives the first attribute request message that requests each attribute value of the first attribute group. When having received the first attribute request message, the server device 202 generates the first attribute disclosure message indicating each attribute value included in the one or more attributes of the first attribute group, and transmits the first attribute disclosure message to the information processing device 201.

The server device 202 receives the second attribute request message that requests each attribute value of the second attribute group. When having received the second attribute request message, the server device 202 generates the second attribute disclosure message indicating each attribute value included in the one or more attributes of the second attribute group, and transmits the second attribute disclosure message to the information processing device 201. The server device 202 is, for example, a server, a PC, or the like.

The client device 203 is a computer used by the service user. The client device 203 accepts designation of the purpose of using the predetermined service provided by the server device 202 based on an operation input by the service user. The client device 203 transmits, to the information processing device 201, the coupling request for the server device 202 including the designated purpose.

The client device 203 performs the target procedure for the server device 202 under the control of the information processing device 201. The client device 203 performs the first processing for the server device 202 under the control of the information processing device 201, for example. The client device 203 performs the second processing for the server device 202 under the control of the information processing device 201, for example. The client device 203 is, for example, a PC, a tablet terminal, a smartphone, or the like.

(Application Example of Information Processing System 200)

Next, an application example of the information processing system 200 illustrated in FIG. 2 will be described. The information processing system 200 illustrated in FIG. 2 can be applied in a case where the server device 202 provides a shopping service to the service user, for example. Thereby, the information processing system 200 enables the service user to accurately evaluate the reliability of the service provider. The information processing system 200 enables the service user to easily avoid suffering damage due to a fraudulent behavior by the service provider, for example.

The information processing system 200 enables two people who do not know each other to easily communicate online in a relatively safely manner. The information processing system 200 enables two people who do not know each other to easily communicate online. Therefore, the information processing system 200 can activate economic activities, creative activities, or the like online.

The information processing system 200 can control the second device 102 to prepare each attribute value of the second attribute group in the second device 102 while performing the first processing. Therefore, the information processing system 200 can cause the second device 102 to prepare the each attribute value of the second attribute group before desiring to start the second processing while the service user is involved in the first processing, for example.

Therefore, for example, the information processing system 200 can quickly determine whether or not to perform the second processing at timing when the service user desires to start the second processing, and can quickly start the second processing. Alternatively, for example, the information processing system 200 can determine whether or not to perform the second processing before the service user desires to start the second processing, and can quickly start the second processing. Therefore, the information processing system 200 can improve convenience of services.

(Hardware Configuration Example of Information Processing Device 201)

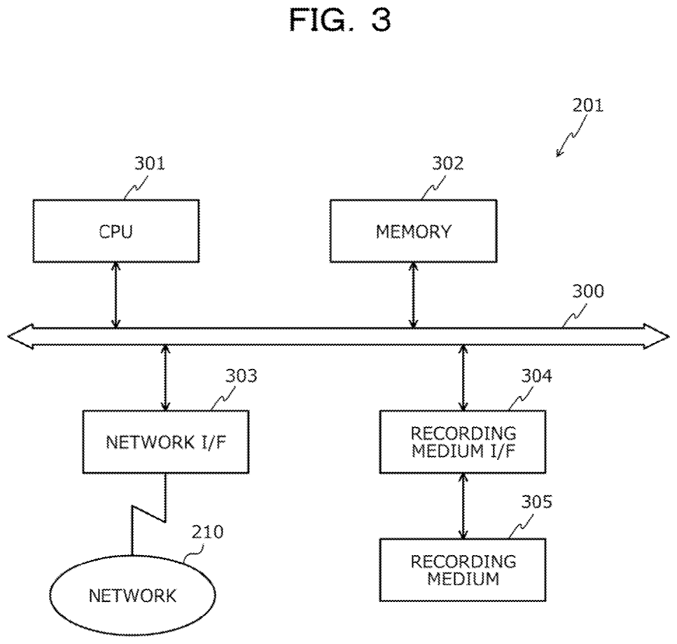

Next, a hardware configuration example of the information processing device 201 will be described with reference to FIG. 3.

FIG. 3 is a block diagram illustrating the hardware configuration example of the information processing device 201. In FIG. 3, the information processing device 201 includes a central processing unit (CPU) 301, a memory 302, a network interface (I/F) 303, a recording medium I/F 304, and a recording medium 305. Furthermore, the individual configuration units are coupled to each other by a bus 300.

Here, the CPU 301 performs overall control of the information processing device 201. The memory 302 includes, for example, a read only memory (ROM), a random access memory (RAM), a flash ROM, and the like. For example, the flash ROM or the ROM stores various programs, and the RAM is used as a work area for the CPU 301. The programs stored in the memory 302 are loaded into the CPU 301 to cause the CPU 301 to execute coded processing.

The memory 302 stores, for example, the attribute-related information management table 400, which will be described below with reference to FIG. 4. The memory 302 stores, for example, the level information management table 500, which will be described below with reference to FIG. 5.

The network I/F 303 is coupled to the network 210 through a communication line, and is coupled to another computer via the network 210. Then, the network I/F 303 conducts an interface between the network 210 and the inside, and controls input/output of data to/from the another computer. The network I/F 303 is, for example, a modem, a LAN adapter, or the like.

The recording medium I/F 304 controls read/write of data from/to the recording medium 305 under the control of the CPU 301. The recording medium I/F 304 is, for example, a disk drive, a solid state drive (SSD), a universal serial bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be attachable to and detachable from the information processing device 201.

The information processing device 201 may include, for example, a keyboard, a mouse, a display, a printer, a scanner, a microphone, a speaker, or the like in addition to the above-described configuration units. Furthermore, the information processing device 201 may include a plurality of the recording medium I/Fs 304 and the recording media 305. Furthermore, the information processing device 201 does not have to include the recording medium I/F 304 or the recording medium 305.

(Content Stored in Attribute-related Information Management Table 400)

Next, an example of content stored in the attribute-related information management table 400 will be described with reference to FIG. 4. The attribute-related information management table 400 is implemented by a storage area such as the memory 302 or the recording medium 305 of the information processing device 201 illustrated in FIG. 3, for example.

FIG. 4 is an explanatory table illustrating an example of content stored in the attribute-related information management table 400. As illustrated in FIG. 4, the attribute-related information management table 400 has fields of purpose, attribute x, stage 1 threshold, and stage 2 threshold. x is an arbitrary integer. In the example of FIG. 4, x is 1, 2, . . . , N. The attribute-related information management table 400 stores attribute-related information as a record 400-a by setting information in each field for each procedure. a is an arbitrary integer.

In the field of purpose, the purpose of using the service provided by the server device 202 is set. The purpose represents the type of the procedure to be performed for the server device 202. In the field of attribute x, an evaluation rule indicating what attribute value is to be referred to in order to evaluate the reliability of the server device 202 before performing the above-described procedure for the server device 202 for the above-described purpose is set. The evaluation rule includes, for example, the attribute types.

The evaluation rule includes score 1, which is specified as the score corresponding to the attribute value when the attribute value falls under level 3. The evaluation rule includes score 2, which is specified as the score corresponding to the attribute value when the attribute value falls under level 2. The evaluation rule includes score 3, which is specified as the score corresponding to the attribute value when the attribute value falls under level 1. The score is an element that indicates the degree of reliability of the server device 202. The score indicates that the higher the value, the higher the reliability of the server device 202 is evaluated. Level i indicates that the attribute value contributes relatively more to the reliability of the server device 202 as the value of i is larger.

In the field of stage 1 threshold, a stage 1 threshold that serves as a criterion for determining whether or not to perform stage 1 processing of forming the above-described procedure is set. The stage 1 processing is, for example, processing for the client device 203 to be coupled to the server device 202. In the field of stage 2 threshold, a stage 2 threshold that serves as a criterion for determining whether or not to perform stage 2 processing of forming the above-described procedure is set. The stage 2 processing is, for example, processing for the client device 203 to conduct a transaction in the server device 202. The transaction is, for example, purchase of goods or the like.

(Content Stored in Level Information Management Table 500)

Next, an example of content stored in the level information management table 500 will be described with reference to FIG. 5. The level information management table 500 is implemented by a storage area such as the memory 302 or the recording medium 305 of the information processing device 201 illustrated in FIG. 3, for example.

FIG. 5 is an explanatory table illustrating an example of content stored in the level information management table 500. As illustrated in FIG. 5, the level information management table 500 has fields of attribute type and level y. y is an arbitrary integer. In the example of FIG. 5, y is, for example, 3, 2, or 1. The level information management table 500 stores level information as a record 500-b by setting information in each field for each attribute related to the server device 202. b is an arbitrary integer.

In the field of attribute type, the attribute type related to the server device 202 is set. In the field of level y, a condition z for determining that the above-described attribute value matches the level y is set. For example, in a case where the above-described attribute value is determined to match the level y, the above-described attribute value is determined to correspond to score z.

Here, a case in which y is 3, 2, or 1 has been described, but the present embodiment is not limited to this. For example, there may be case in which y is M, M−1, . . . , 1. In this case, the content stored in the attribute-related information management table 400 and the level information management table 500 is changed according to the number of y.

(Hardware Configuration Example of Server Device 202)

Since a hardware configuration example of the server device 202 is similar to the hardware configuration example of the information processing device 201 illustrated in FIG. 3, for example, description thereof is omitted.

(Hardware Configuration Example of Client Device 203)

Since a hardware configuration example of the client device 203 is similar to the hardware configuration example of the information processing device 201 illustrated in FIG. 3, for example, description thereof is omitted.

(Example of Functional Configuration of Information Processing Device 201)

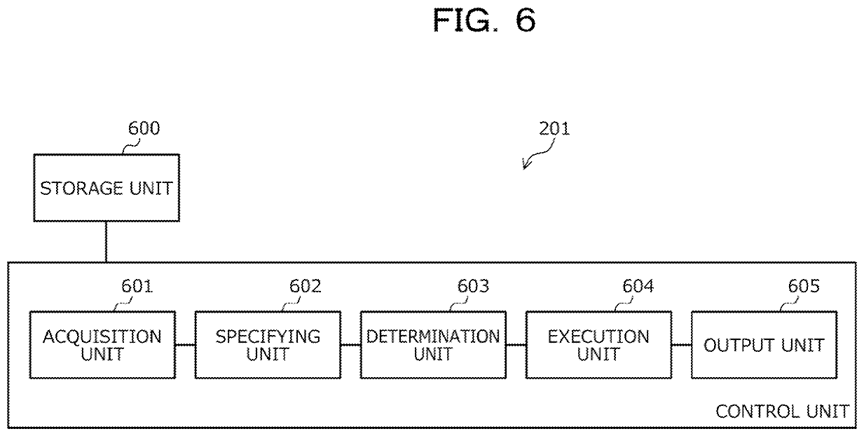

Next, an example of a functional configuration of the information processing device 201 will be described with reference to FIG. 6. In the following description, the information processing device 201 corresponds to the first device 101 and can communicate with the second device 102, for example. The second device 102 corresponds to the server device 202, for example.

FIG. 6 is a block diagram illustrating an example of a functional configuration of the information processing device 201. The information processing device 201 includes a storage unit 600, an acquisition unit 601, a specifying unit 602, a determination unit 603, an execution unit 604, and an output unit 605.

The storage unit 600 is implemented by, for example, the storage area such as the memory 302 or the recording medium 305 illustrated in FIG. 3. Hereinafter, a case where the storage unit 600 is included in the information processing device 201 will be described, but the present embodiment is not limited to this. For example, there may be a case where the storage unit 600 is included in a device different from the information processing device 201, and the content stored in the storage unit 600 can be referred to by the information processing device 201.

The acquisition unit 601 to the output unit 605 function as an example of a control unit. For example, the acquisition unit 601 through the output unit 605 implement functions thereof by causing the CPU 301 to execute a program stored in the storage area such as the memory 302 or the recording medium 305 or by the network I/F 303 illustrated in FIG. 3. A processing result of each functional unit is stored in, for example, the storage area such as the memory 302 or the recording medium 305 illustrated in FIG. 3.

The storage unit 600 stores various types of information to be referred to or updated in the processing of each functional unit. The storage unit 600 stores, for example, an attribute group related to the second device 102 in association with each type of procedure. The procedure is performed for the second device 102, for example. For example, the storage unit 600 stores the attribute-related information indicating each attribute type of the attribute group related to the second device 102 in an association with each type of procedure. For example, the storage unit 600 stores the attribute-related information management table 400 illustrated in FIG. 4.

The storage unit 600 stores, for each attribute of the second device 102, information that enables specification of the score indicating the reliability of the second device 102 corresponding to the attribute value, for example. For example, the storage unit 600 stores the level information including the attribute type, the condition z for determining that the attribute value matches each level y of a plurality of levels, and the score z set as the score corresponding to the attribute value in the case of satisfying the condition. For example, the storage unit 600 stores the level information management table 500 illustrated in FIG. 5.

The storage unit 600 stores, for example, a reference score to be used when determining whether or not to perform a procedure. The procedure includes, for example, the first processing performed for the second device 102 and the second processing performed for the second device 102 after the first processing. The storage unit 600 stores, for example, a first reference score to be used when determining whether or not to perform the first processing of the procedure.

The storage unit 600 stores, for example, a second reference score to be used when determining whether or not to perform the second processing of the procedure. The second reference score is favorably a larger value than the first reference score, for example. For example, the storage unit 600 stores the attribute-related information management table 400 illustrated in FIG. 4.

The storage unit 600 may store, for each address, the type of the procedure to be performed for the second device 102 corresponding to the address in association with each other. The address is, for example, a uniform resource locator (URL), an internet protocol (IP) address, or the like. Thereby, the storage unit 600 enables specification of the target procedure to be performed for the second device 102 based on the address.

The acquisition unit 601 acquires various types of information to be used for the processing of each functional unit. The acquisition unit 601 stores the acquired various types of information in the storage unit 600 or outputs the acquired various types of information to each functional unit. Furthermore, the acquisition unit 601 may also output the various types of information stored in the storage unit 600 to each functional unit. The acquisition unit 601 acquires the various types of information based on an operation input by the local device user, for example. The local device user is, for example, the service user or a system administrator who manages the information processing system 200. The acquisition unit 601 may receive the various types of information from, for example, a device different from the information processing device 201.

The acquisition unit 601 accepts, for example, an input of a combination of the type of procedure and the first attribute group related to the second device 102. The combination may further include, for each attribute value, information that enables specification of the score indicating the reliability related to the second device 102, the score corresponding to the attribute value.

For example, the acquisition unit 601 accepts the combination by receiving a combination of the type of procedure and the first attribute group related to the second device 102 from the another computer. The another computer is, for example, the client device 203. For example, the acquisition unit 601 accepts the input of the combination of the type of procedure and the first attribute group related to the second device 102 based on the operation input by the local device user.

The acquisition unit 601 updates the content stored in the storage unit 600 based on the accepted combination, for example. For example, the acquisition unit 601 updates the content stored in the attribute-related information management table 400 based on the accepted combination. As a result, the acquisition unit 601 can reflect an intention of the service user in the content stored in the storage unit 600, and enables accurate determination as to whether or not to perform the target procedure for the second device 102.

The acquisition unit 601 acquires, for example, a start notification indicating that the target procedure is to be started. For example, the acquisition unit 601 acquires the start notification by receiving the notification from the another computer. The another computer is, for example, the client device 203. For example, the acquisition unit 601 may acquire the start notification by accepting an input of the start notification based on the operation input by the local device user.

The acquisition unit 601 acquires, for example, the type of the target procedure. For example, the acquisition unit 601 acquires the type of the target procedure by receiving the start notification including the type of the target procedure from the another computer. The another computer is, for example, the client device 203. For example, the acquisition unit 601 may acquire the type of the target procedure by accepting an input of the start notification including the type of the target procedure based on the operation input by the local device user.

The acquisition unit 601 acquires the address of the second device 102, for example. For example, the acquisition unit 601 acquires the address of the second device 102 by receiving the start notification including the address of the second device 102 from the another computer. The another computer is, for example, the client device 203. For example, the acquisition unit 601 may acquire the address of the second device 102 by accepting an input of the start notification including the address of the second device 102 based on the operation input by the local device user.

The acquisition unit 601 may also accept a start trigger to start processing of any functional unit. The start trigger is, for example, a predetermined operation input by the local device user. The start trigger may be, for example, reception of predetermined information from the another computer. The start trigger may be, for example, output of predetermined information by any functional unit. For example, the acquisition unit 601 may accept the acquisition of the start notification as the start trigger for starting the processing of the specifying unit 602, the determination unit 603, and the execution unit 604.

The specifying unit 602 specifies the type of the target procedure based on the address of the second device 102. The specifying unit 602 specifies the type of a procedure associated with the address of the second device 102 as the type of the target procedure by referring to the storage unit 600, for example. As a result, the specifying unit 602 allows the service user to omit the need to specify the type of the target procedure, thereby reducing a work load on the service user.

The specifying unit 602 refers to the storage unit 600 and specifies the first attribute group corresponding to the type of the target procedure to be performed for the second device 102. The specifying unit 602 refers to the attribute-related information management table 400, for example, and specifies the first attribute group corresponding to the type of the target procedure to be performed for the second device 102. As a result, the specifying unit 602 can evaluate the reliability of the second device 102, specify the attribute type to be referred to when determining whether or not to perform the target procedure, and make the attribute value requestable to the second device 102.

The specifying unit 602 transmits a first transmission request for each attribute value of the specified first attribute group to the second device 102. The first transmission request requests the second device 102 to provide the first device 101 with each attribute value of the first attribute group. The first transmission request includes, for example, each attribute type of the first attribute group. The specifying unit 602 receives each attribute value of one or more attributes included in the first attribute group from the second device 102 in response to the transmitted first transmission request. Thereby, the specifying unit 602 enables evaluation of the reliability of the second device 102 and enables determination as to whether or not to perform the target procedure.

The determination unit 603 determines whether or not to perform the target procedure based on each attribute value of the one or more attributes included in the first attribute group received by the specifying unit 602 from the second device 102 in response to the first transmission request. The determination unit 603 refers to the storage unit 600, for example, and specifies the score corresponding to each attribute value of the one or more attributes included in the first attribute group received by the specifying unit 602 from the second device 102 in response to the first transmission request. The determination unit 603 determines whether or not to perform the target procedure based on a total score obtained by adding the specified scores, for example.

For example, the determination unit 603 determines to perform the target procedure in a case where the total score is equal to or higher than the reference score corresponding to the target procedure. For example, the determination unit 603 determines not to perform the target procedure in a case where the total score is less than the reference score corresponding to the target procedure. Thereby, the determination unit 603 can accurately determine whether or not to perform the target procedure. The determination unit 603 can change the number of attributes and the attribute types to be used when evaluating the reliability of the second device 102 in accordance with the type of the target procedure, for example. Therefore, the determination unit 603 can accurately evaluate the reliability of the second device 102 and accurately determine whether or not to perform the target procedure, for example.

The determination unit 603 determines whether or not to perform the first processing based on each attribute value of the one or more attributes included in the first attribute group received from the second device 102 in response to the first transmission request. The determination unit 603 refers to the storage unit 600, for example, and specifies a first score corresponding to each attribute value of the one or more attributes included in the first attribute group received from the second device 102 in response to the first transmission request. The determination unit 603 determines whether or not to perform the first processing based on a first total score obtained by adding the specified first scores, for example.

For example, the determination unit 603 determines to perform the first processing in a case where the first total score is equal to or higher than the first reference score. For example, the determination unit 603 determines not to perform the first processing in a case where the first total score is less than the first reference score. Thereby, the determination unit 603 can evaluate whether or not the second device 102 has reliability of being allowed to perform the first processing of forming the target procedure. The determination unit 603 can determine whether or not to perform at least the first processing of the target procedure.

The determination unit 603 determines whether or not to perform the second processing based on each attribute value of the one or more attributes included in the first attribute group received from the second device 102 in response to the first transmission request. The determination unit 603 refers to the storage unit 600, for example, and specifies the first score corresponding to each attribute value of the one or more attributes included in the first attribute group received from the second device 102 in response to the first transmission request. The determination unit 603 determines whether or not to perform the second processing based on the first total score obtained by adding the specified first scores, for example.

For example, the determination unit 603 determines to perform the second processing in a case where the first total score is equal to or higher than the second reference score. For example, the determination unit 603 determines not to perform the second processing in a case where the first total score is less than the second reference score. Thereby, the determination unit 603 can evaluate whether or not the second device 102 has reliability of being allowed to perform the second processing of forming the target procedure. The determination unit 603 can determine whether or not to perform the second processing in addition to the first processing of the target procedure.

Here, a case in which the determination unit 603 determines whether or not to perform the first processing and whether or not to perform the second processing based on each attribute value of the one or more attributes included in the first attribute group has been described, but the present embodiment is not limited to this. For example, there may be a case in which the determination unit 603 does not determine whether or not to perform the second processing based on each attribute value of the one or more attributes included in the first attribute group.

In the case where the determination unit 603 determines to perform the target procedure, the execution unit 604 starts the target procedure for the second device 102. Thereby, the execution unit 604 starts the target procedure for the second device 102 and can control the second device 102 so that the first device 101 and the second device 102 properly communicate.

In the case where the determination unit 603 determines to perform the first processing, the execution unit 604 starts the first processing for the second device 102. In the case where the determination unit 603 determines to perform the second processing, the execution unit 604 starts the second processing. For example, after starting the first processing, the execution unit 604 starts the second processing for the second device 102 at predetermined timing for performing the second processing. Thereby, the execution unit 604 starts the first processing and the second processing in stages for the second device 102 and can control the second device 102 so that the first device 101 and the second device 102 properly communicate.

In the case of determining to perform the first processing, the specifying unit 602 specifies the second attribute group related to the second device 102 based on each attribute value of the one or more attributes included in the first attribute group received from the second device 102 in response to the first transmission request. Here, the specifying unit 602 may specify the second attribute group from the first attribute group, for example.

The specifying unit 602 specifies the second attribute group related to the second device 102 based on a shortfall by which the first total score falls short of the second reference score, for example. For example, the specifying unit 602 refers to the level information management table 500 and specifies the second attribute group including an attribute associated with a score that can compensate for the shortfall. As a result, the specifying unit 602 can evaluate the reliability of the second device 102, specify the attribute type to be referred to when determining whether or not to perform the second processing, and make the attribute value requestable to the second device 102.

The specifying unit 602 may specify the second attribute group related to the second device 102 based on each attribute value of the one or more attributes included in the first attribute group received from the second device 102 in response to the first transmission request in the case of determining to perform the first processing but not to perform the second processing. Here, the specifying unit 602 may specify the second attribute group from the first attribute group, for example.

The specifying unit 602 specifies the second attribute group related to the second device 102 based on a shortfall by which the first total score falls short of the second reference score, for example. For example, the specifying unit 602 refers to the level information management table 500 and specifies the second attribute group including an attribute associated with a score that can compensate for the shortfall. As a result, the specifying unit 602 can evaluate the reliability of the second device 102, specify the attribute type to be referred to when determining whether or not to perform the second processing, and make the attribute value requestable to the second device 102.

For example, the specifying unit 602 does not have to specify the second attribute group related to the second device 102 in the case of determining to perform the second processing. As a result, the specifying unit 602 can avoid additionally requesting the second device 102 to provide the attribute value in a case of evaluating the presence of the reliability of being allowed to perform the second processing based only on each attribute value of the one or more attributes included in the first attribute group. Therefore, the specifying unit 602 can reduce a processing load on the local device and a processing load on the second device 102.

The specifying unit 602 transmits a second transmission request for each attribute value of the specified second attribute group to the second device 102. The second transmission request requests the second device 102 to provide the first device 101 with each attribute value of the second attribute group. The second transmission request includes, for example, each attribute type of the second attribute group. The specifying unit 602 starts the first processing and transmits the second transmission request of each attribute value of the specified second attribute group to the second device 102 before completing the first processing, for example.

Thereby, the specifying unit 602 can enable the second device 102 to start the operation to acquire each attribute value of the second attribute group after the first processing is started and before the start of the second processing is desired. For this reason, the specifying unit 602 enables the second device 102 to easily prepare each attribute value of the second attribute group before the start of the second processing is desired, using a grace time before the second processing is started. The specifying unit 602 can reduce a waiting time in a case where the service user desires to start the second processing and can improve the convenience.

The determination unit 603 determines whether or not to perform the second processing based on each attribute value of the one or more attributes included in the second attribute group received from the second device 102 in response to the second transmission request. The determination unit 603 refers to the storage unit 600, for example, and specifies a second score corresponding to each attribute value of the one or more attributes included in the second attribute group received from the second device 102 in response to the second transmission request. The determination unit 603 determines whether or not to perform the second processing based on a second total score obtained by adding the specified second scores, for example.

For example, the determination unit 603 determines to perform the second processing in a case where the second total score is equal to or higher than the second reference score. For example, the determination unit 603 determines not to perform the second processing in a case where the second total score is less than the second reference score. Thereby, the determination unit 603 can evaluate whether or not the second device 102 has the reliability of being allowed to perform the second processing of forming the target procedure. Since the determination unit 603 gives the second device 102 time to prepare each attribute value of the second attribute group, it is possible to properly improve a probability of determining to perform the second processing.

Here, for example, it is assumed that an attribute group in which one or more attributes included in the first attribute group of which the values have been received and one or more attributes included in the second attribute group of which the values have been received are integrated without duplication is referred to as a “third attribute group”. The determination unit 603 may refer to the storage unit 600 and specify a third score corresponding to each attribute value in the third attribute group, for example. The determination unit 603 determines whether or not to perform the second processing based on a third total score obtained by adding the specified third scores, for example.

For example, the determination unit 603 determines to perform the second processing in a case where the third total score is equal to or higher than the second reference score. For example, the determination unit 603 determines not to perform the second processing in a case where the third total score is less than the second reference score. Thereby, the determination unit 603 can evaluate whether or not the second device 102 has the reliability of being allowed to perform the second processing of forming the target procedure. Since the determination unit 603 gives the second device 102 time to prepare each attribute value of the second attribute group, it is possible to properly improve the probability of determining to perform the second processing.

In the case where the determination unit 603 determines to perform the second processing, the execution unit 604 starts the second processing. The execution unit 604 starts the second processing for the second device 102, for example. Thereby, the execution unit 604 starts the second processing in stages for the second device 102 and can control the second device 102 so that the first device 101 and the second device 102 properly communicate.

The output unit 605 outputs a processing result of at least one of the functional units. An output format is, for example, display on a display, print output to a printer, transmission to an external device by the network I/F 303, or storage in a storage area such as the memory 302 or the recording medium 305. Thereby, the output unit 605 can make it possible for the local device user to be notified of the processing result of at least one of the functional units, and may achieve improvement in convenience of the information processing device 201.

The output unit 605 outputs the determination result of the determination unit 603. For example, in the case of determining not to perform the target procedure, the output unit 605 outputs an alert indicating that the target procedure is not to be performed. Thereby, the output unit 605 evaluates that the second device 102 is unreliable and enables the service user to understand that the target procedure is not to be performed.

In the case of determining not to perform the first processing, the output unit 605 outputs a first alert indicating that the first processing is not to be performed. Thereby, the output unit 605 evaluates that the second device 102 is unreliable and enables the service user to understand that the first processing is not to be performed.

In the case of determining not to perform the second processing, the output unit 605 outputs a second alert indicating that the second processing is not to be performed. Thereby, the output unit 605 evaluates that the second device 102 is unreliable and enables the service user to understand that the second processing is not to be performed.

(Specific Example of Functional Configuration of Information Processing Device 201)

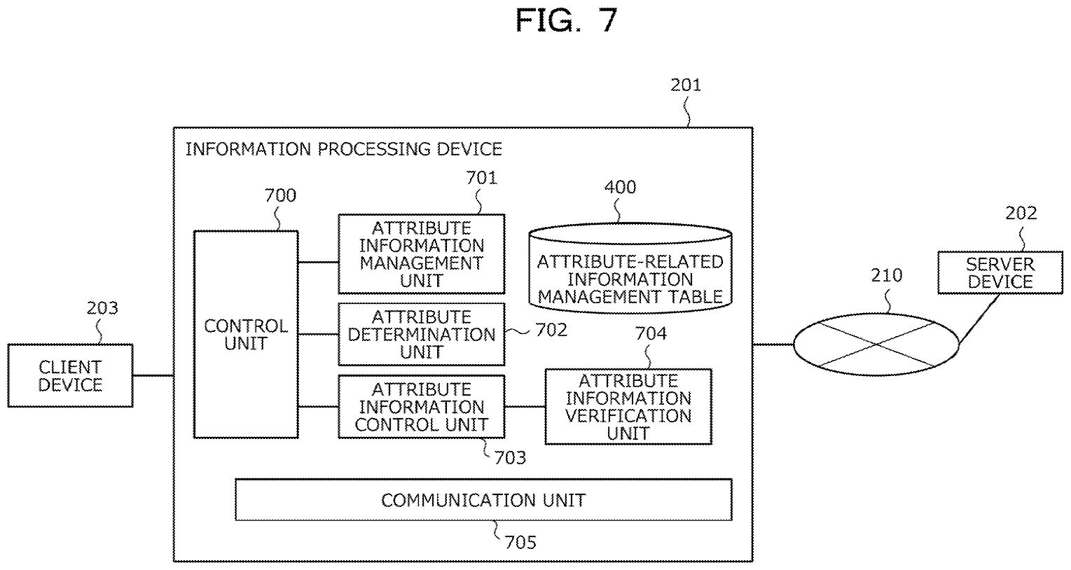

Next, a specific example of a functional configuration of the information processing device 201 will be described with reference to FIG. 7.

FIG. 7 is a block diagram illustrating a specific example of the functional configuration of the information processing device 201. In FIG. 7, the information processing device 201 includes a control unit 700. The information processing device 201 includes an attribute information management unit 701, an attribute determination unit 702, an attribute information control unit 703, and an attribute information verification unit 704, each of which is controlled by the control unit 700. The information processing device 201 includes a communication unit 705.

The control unit 700 controls the attribute information management unit 701, the attribute determination unit 702, the attribute information control unit 703, and the attribute information verification unit 704 to implement the above-described acquisition unit 601 to output unit 605. The control unit 700 manages exchange of data among the attribute information management unit 701, the attribute determination unit 702, the attribute information control unit 703, and the attribute information verification unit 704.

The attribute information management unit 701 manages the attribute-related information management table 400. For example, the attribute information management unit 701 receives a combination of the purpose of using the service provided by the server device 202 and the attribute group related to the server device 202 from the client device 203 via the communication unit 705, and updates the content stored in the attribute-related information management table 400.

The attribute determination unit 702 receives a request message including the purpose of using the service provided by the server device 202 and requesting the use of the service provided by the server device 202 from the client device 203 via the communication unit 705. The attribute determination unit 702 refers to the attribute-related information management table 400, and specifies each attribute type of the first attribute group, the value of the each attribute type being requested to the server device 202 to disclose based on the purpose included in the request message.

The attribute information control unit 703 generates the first attribute request message that includes the specified each attribute type of the first attribute group and requests the server device 202 to disclose the each attribute value of the first attribute group, and transmits the first attribute request message to the server device 202 via the communication unit 705.

The attribute information verification unit 704 receives the first attribute disclosure message that indicates each attribute value included in the one or more attributes of the first attribute group from the server device 202 via the communication unit 705. The attribute information verification unit 704 specifies a first attribute point indicating the reliability of the server device 202, the first attribute point corresponding to each attribute value based on the each attribute value included in the one or more attributes of the first attribute group indicated by the first attribute disclosure message.

The attribute information verification unit 704 determines whether or not a total point of the first attribute points is equal to or greater than a coupling threshold. The coupling threshold is, for example, a criterion for permitting access to the server device 202 to browse service information. The service information is, for example, goods information. In a case where the total point is equal to or greater than the coupling threshold, the attribute information verification unit 704 controls communication between the server device 202 and the client device 203 so that the client device 203 is coupled to the server device 202 and becomes able to browse the service information using the communication unit 705.

The attribute information verification unit 704 determines whether or not the total point of the first attribute points is equal to or greater than a transaction threshold. The transaction threshold is, for example, a criterion for permitting a transaction with the service provider. The transaction is, for example, buying and selling of goods. In a case where the total point is equal to or greater than the transaction threshold, the attribute information verification unit 704 controls communication between the server device 202 and the client device 203 so that the client device 203 becomes able to conduct the transaction with the service provider, using the communication unit 705.

The attribute determination unit 702 specifies each attribute type of the second attribute group, the value of the each attribute type being additionally requested to the server device 202 to disclose. The attribute determination unit 702 specifies each attribute type of the second attribute group, the value of the each attribute type being additionally requested to the server device 202 to disclose, of the first attribute group, for example.

The attribute information control unit 703 generates the second attribute request message that includes the specified each attribute type of the second attribute group and requests the server device 202 to disclose the each attribute value of the second attribute group, and transmits the second attribute request message to the server device 202 via the communication unit 705.

The attribute information verification unit 704 receives the second attribute disclosure message that indicates each attribute value included in the one or more attributes of the second attribute group from the server device 202 via the communication unit 705. The attribute information verification unit 704 specifies a second attribute point indicating the reliability of the server device 202, the second attribute point corresponding to each attribute value based on the each attribute value included in the one or more attributes of the second attribute group indicated by the second attribute disclosure message.

The attribute information verification unit 704 determines whether or not a total point of the second attribute points is equal to or greater than the transaction threshold. The transaction threshold is, for example, a criterion for permitting a transaction with the service provider. The transaction is, for example, buying and selling of goods. In a case where the total point is equal to or greater than the transaction threshold, the attribute information verification unit 704 controls communication between the server device 202 and the client device 203 so that the client device 203 becomes able to conduct the transaction with the service provider, using the communication unit 705.

The communication unit 705 controls communication between the local device and the client device 203. The communication unit 705 controls communication between the local device and the server device 202. The communication unit 705 relays the communication between the server device 202 and the client device 203 to enable the server device 202 and the client device 203 to communicate, for example.

(Operation Example of Information Processing Device 201)

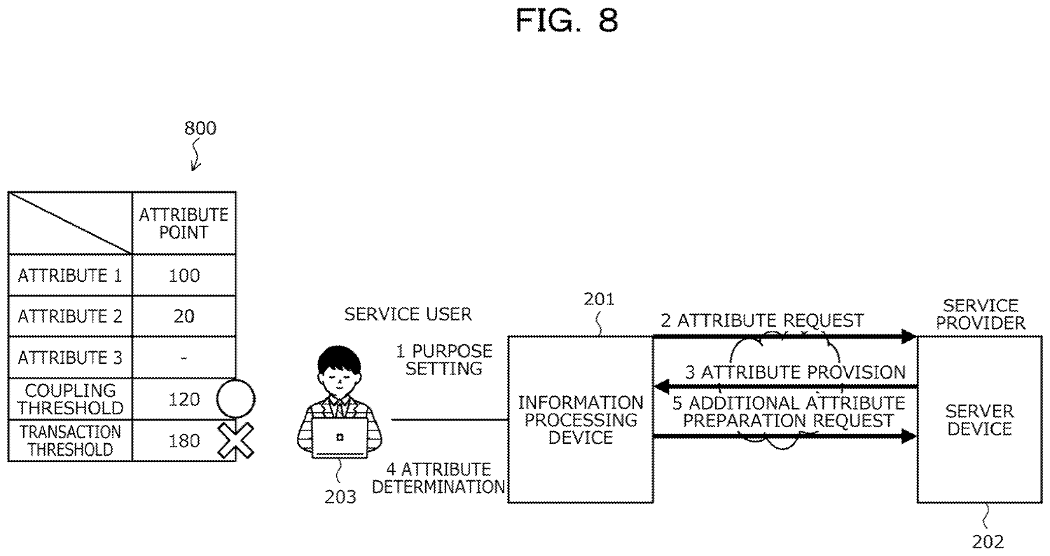

Next, operation examples of the information processing device 201 will be described with reference to FIGS. 8 to 12.

FIGS. 8 to 12 are explanatory diagrams illustrating operation examples of the information processing device 201. In FIG. 8, the service user inputs the attribute-related information including attribute information, an attribute point corresponding to an attribute level, the coupling threshold, and the transaction threshold to the client device 203 for each purpose of using the service. The attribute information is, for example, an element for evaluating the reliability of the server device 202 that provides the service. The attribute information includes, for example, an attribute value. The attribute information may include, for example, the degree of credibility of the attribute value. The client device 203 transmits the input attribute-related information to the information processing device 201.

For example, the information processing device 201 may associate a template of the attribute-related information with each purpose of using the service, and transmit the template to the client device 203, thereby providing the service user with the template, in terms of operation. The client device 203 generates the attribute-related information in accordance with the intention of the service user by changing setting values of the template based on the operation input of the service user, and transmits the attribute-related information to the information processing device 201. The information processing device 201 reflects the received attribute-related information in the attribute-related information management table 400.

(8-1) The information processing device 201 receives the request message including the purpose of using the service provided by the server device 202 and requesting the use of the service provided by the server device 202 from the client device 203. The information processing device 201 extracts the purpose of using the service from the request message and sets the extracted purpose as a target purpose. It is assumed that, in the example of FIG. 8, the information processing device 201 sets “purchase” as the target purpose.

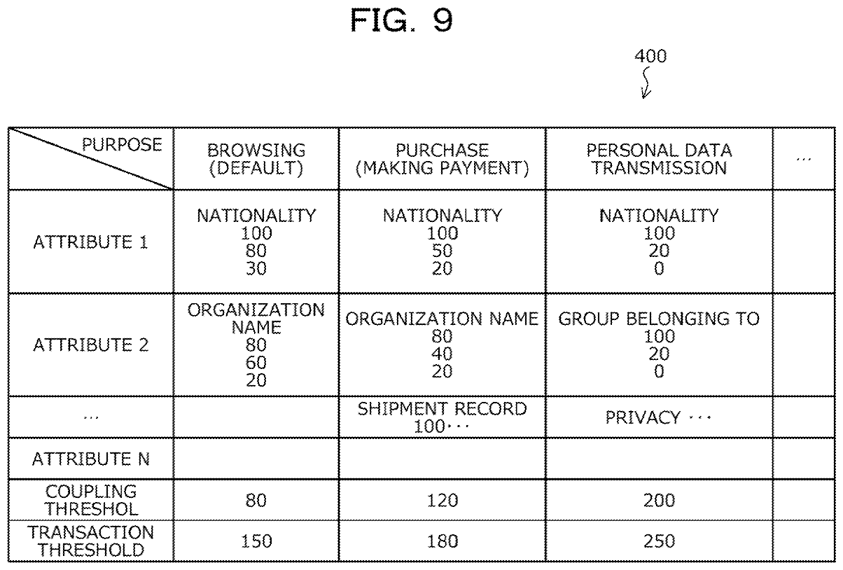

(8-2) The information processing device 201 refers to the attribute-related information management table 400 and specifies the first attribute group that requests the server device 202 to disclose the values corresponding to the set target purpose. The information processing device 201 generates the first attribute request message that requests disclosure of each attribute value of the specifies first attribute group, and transmits the first attribute request message to the server device 202. Here, the description will move onto FIG. 9, and an example in which the information processing device 201 generates the first attribute request message will be described.

As illustrated in FIG. 9, the information processing device 201 specifies each attribute type “nationality”, “organization name”, “shipment record”, or the like corresponding to the target purpose “purchase” as each attribute type of the first attribute group. The information processing device 201 generates the first attribute request message that includes each attribute type “nationality”, “organization name”, “shipment record”, or the like, and requests disclosure of the each attribute value.

Returning to the description of FIG. 8, (8-3) the server device 202 receives the first attribute request message. When having received the first attribute request message, the server device 202 generates a first attribute provision message including the attribute information indicating each attribute value included in the one or more attributes of the first attribute group and credibility information regarding the attribute value, and transmits the first attribute provision message to the information processing device 201.

It is assumed that the server device 202 has already acquired each attribute value of the one or more attributes of the first attribute group, for example. For example, it is assumed that the server device 202 has already acquired a certificate, VC, or the like. Therefore, for example, the server device 202 generates the first attribute request message including the attribute information indicating the acquired each attribute value and the credibility information regarding the attribute value, and transmits the first attribute request message to the information processing device 201.

Here, it is assumed that the server device 202 has already acquired the attribute value “priority nationality” of the “nationality”, but has not yet acquired the attribute value “electronic corporate registration” of the “organization name”. Therefore, the server device 202 is not able to include the value “electronic corporate registration” of the “organization name” in the first attribute provision message. The server device 202 generates the first attribute provision message including, for example, the value “priority nationality” of the “nationality” and credibility information “certificate of public institution” regarding the attribute value, and a value “self-reported” of the “organization name”. The information processing device 201 receives the first attribute provision message from the server device 202.

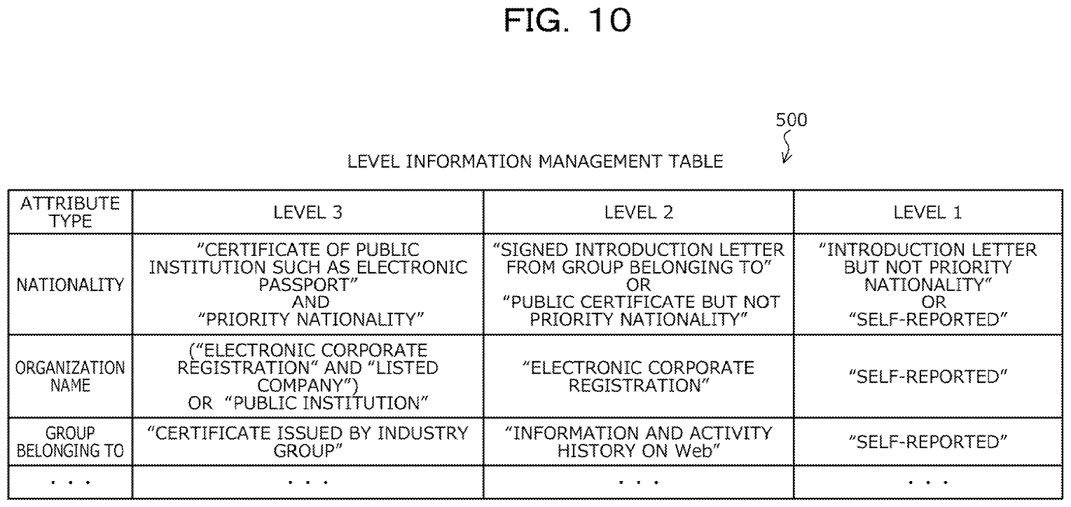

(8-4) The information processing device 201 refers to the level information management table 500, and determines, based on each attribute value included in the one or more attributes and the credibility information regarding the attribute value indicated by the first attribute provision message, the attribute level of the attribute. Here, the description will move onto FIG. 10, and an example in which the information processing device 201 determines the attribute level will be described.

As illustrated in FIG. 10, the information processing device 201 refers to the level information management table 500, and determines that the combination of the value “priority nationality” of the “nationality” and the credibility information “certificate of public institution” regarding the attribute value is the attribute level “3”. The information processing device 201 refers to the level information management table 500 and determines that the value “self-reported” of the “organization name” is the attribute level “1”.

Returning to the description of FIG. 8, the information processing device 201 refers to the attribute-related information management table 400 and determines the attribute point corresponding to the determined attribute level of each attribute. The information processing device 201 refers to the attribute-related information management table 400 illustrated in FIG. 9 and determines that the attribute point corresponding to the attribute level “3” of the “nationality” is “100”. The information processing device 201 refers to the attribute-related information management table 400 illustrated in FIG. 9 and determines that the attribute point corresponding to the attribute level “1” of the “organization name” is “20”.

The information processing device 201 calculates the total point obtained by adding the determined attribute points. The information processing device 201 calculates the total point “120”. The information processing device 201 refers to the attribute-related information management table 400 illustrated in FIG. 9, and acquires the coupling threshold “120” and the transaction threshold “180”. The information processing device 201 determines whether or not to perform transaction processing based on whether or not the calculated total point the transaction threshold. The information processing device 201 determines whether or not to perform coupling processing based on whether or not the calculated total point the coupling threshold.

In the case of the total point the transaction threshold, the information processing device 201 evaluates that the reliability of the server device 202 is relatively high, and determines to perform the coupling processing and transaction processing. The information processing device 201 permits the server device 202 and the client device 203 to perform the coupling processing and the transaction processing, and sets them to be able to communicate without restrictions. Thereby, when evaluating that the reliability of the server device 202 is relatively high, the information processing device 201 can enable the server device 202 and the client device 203 to be able to communicate without restrictions at an early stage, thereby improving convenience.

In a case where the total point<the transaction threshold and the total point≥the coupling threshold, the information processing device 201 permits the coupling processing and does not permit the transaction processing, and sets restrictions on some communication, for the server device 202 and the client device 203. Thereby, the information processing device 201 can suspend whether or not to permit the transaction processing and can permit the coupling processing in the case where the server device 202 does not have the reliability for permitting the transaction processing but has the reliability for permitting the coupling processing with a relatively low risk.

For this reason, the information processing device 201 gives the server device 202 the grace time to prepare the attribute value to be additionally disclosed in order to prove the reliability of the server device 202 for permitting the transaction processing. For example, the information processing device 201 can give the server device 202 the grace time to acquire the attribute value “electronic corporate registration” of the “organization name”. Meanwhile, since the information processing device 201 permits the coupling processing, the service user can be less conscious of the waiting time until whether or not to permit the transaction processing is determined again, and the convenience can be improved.

In a case where the total point<the coupling threshold value, the information processing device 201 evaluates that the reliability of the server device 202 is relatively low, does not permit the coupling processing and the transaction processing, and disables the communication between the server device 202 and the client device 203. Thereby, when evaluating that the reliability of the server device 202 is relatively low, the information processing device 201 can determine that the risk of communication between the server device 202 and the client device 203 is relatively high. Then, the information processing device 201 can disable the communication between the server device 202 and the client device 203. Therefore, the information processing device 201 can improve security.

In the example of FIG. 8, the information processing device 201 has determined the attribute points as illustrated in table 800 and has acquired the coupling threshold and the transaction threshold, and thus determines the total point of 120<the transaction threshold of 180, and the total point of 120≥the coupling threshold of 120. For this reason, the coupling processing is permitted, the transaction processing is not permitted, and restrictions on some communication is set for the server device 202 and the client device 203.

(8-5) Since the information processing device 201 has not permitted the transaction processing, the information processing device 201 generates a preparation request message that requests the server device 202 to prepare a value of an additional attribute to be additionally disclosed in order to determine whether or not to perform the transaction processing again. The preparation request message includes, for example, the type of the additional attribute for which preparation of the value is to be requested. The preparation request message may specify a condition such as a lower limit of the value of the additional attribute, for example.

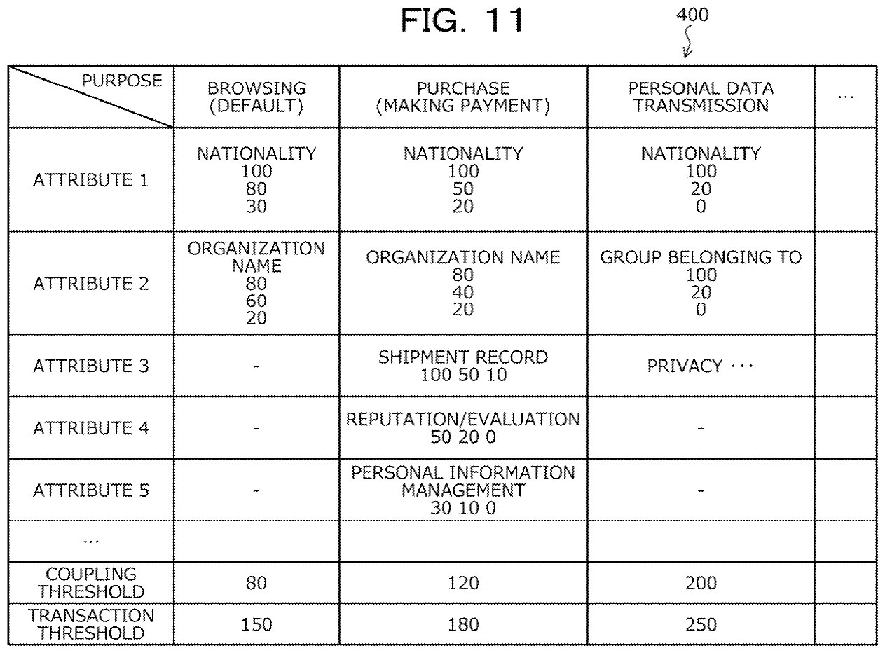

The information processing device 201 refers to the attribute-related information management table 400, for example, and specifies the type of the additional attribute for which preparation of the value is to be requested based on the shortfall of 60 by which the total point of 120 falls short of the transaction threshold of 180. The information processing device 201 may refer to the attribute-related information management table 400, for example, and specify the type of the additional attribute for which preparation of the value is to be requested based on the shortfall of 60 by which the coupling threshold of 120 falls short of the transaction threshold of 180. For example, the information processing device 201 may further specify the condition such as the lower limit of the value of the additional attribute for which preparation of the value is to be requested. Here, the description will move onto FIG. 11, and an example in which the information processing device 201 generates the preparation request message will be described.

In FIG. 11, the information processing device 201 specifies, for example, the attribute types with undisclosed values from among the attribute types “nationality”, “organization name”, “shipment record”, “reputation/evaluation”, and “personal information management” corresponding to the target purpose “purchase”. The information processing device 201 sets, for example, the specified attribute types “shipment record”, “reputation/evaluation”, and “personal information management” as the types of additional attributes for which preparation of values is to be requested.

The information processing device 201 may specify, for example, the attribute types with a relatively low attribute level from among the attribute types “nationality”, “organization name”, “shipment record”, “reputation/evaluation”, and “personal information management” corresponding to the target purpose “purchase”. The information processing device 201 sets, for example, the specified attribute type “organization name” as the type of the additional attribute for which preparation of the value is to be requested.

(a) The information processing device 201 calculates, for example, the transaction threshold of 180−the coupling threshold of 120=the difference of 60. For example, the information processing device 201 specifies one type of attribute by which an increase in the attribute point corresponding to the calculated difference is obtained when the server device 202 discloses the values from among the attribute types corresponding to the target purpose “purpose”.

In the following description, the attribute specified by the information processing device 201 may be referred to as “short attribute”. The short attribute is, for example, an attribute by which it is considered that an increase in the attribute point corresponding to the calculated difference can be obtained without additionally disclosing another attribute value when the server device 202 discloses the value of the short attribute. For example, the information processing device 201 sets the type of the specified short attribute as the type of the additional attribute for which preparation of the value is to be requested.

(b) The information processing device 201 calculates, for example, the transaction threshold of 180−the coupling threshold of 120=the difference of 60. For example, the information processing device 201 specifies a combination of two or more types of attributes by which an increase of the attribute point corresponding to the calculated difference is obtained when the server device 202 discloses the values from among the attribute types corresponding to the target purpose “purpose”.

In the following description, the combination of attributes specified by the information processing device 201 may be referred to as a “priority attribute pair”. The priority attribute pair is, for example, an attribute pair by which it is considered that an increase in the attribute point corresponding to the calculated difference can be obtained when the server device 202 discloses the attribute values of the priority attribute pair. For example, the information processing device 201 sets the attribute types of the specified priority attribute pair as the types of the additional attributes for which preparation of the values is to be requested.

(c) The information processing device 201 may specify, for example, the attribute types with the attribute level of not 3. In the following description, the attribute specified by the information processing device 201 may be referred to as a “credibility addable attribute”. The credibility addable attribute is an attribute that can improve the reliability of the server device 202 when the server device 202 discloses the value, for example. For example, the information processing device 201 sets the specified credibility addable attribute as the type of the additional attribute for which preparation of the value is to be requested.

The information processing device 201 generates the preparation request message including the type of the set additional attribute. The information processing device 201 generates the preparation request message that includes, for example, the type of the short attribute, the type of each attribute of the priority attribute pair, and the type of the credibility addable attribute in a distinguishable manner. The information processing device 201 transmits the generated preparation request message to the server device 202.

The server device 202 receives the preparation request message from information processing device 201. The server device 202 starts processing of acquiring the additional attribute values such as the value of the short attribute, the value of each attribute of the priority attribute pair, and the value of the credibility addable attribute based on the preparation request message. The server device 202 starts processing of acquiring the attribute value “electronic corporate registration” of the “organization name” and the like, for example.

The processing does not have to be completed before the operation of (12-1) to be described below. The processing may be performed in parallel with the operation (12-1) to be described below, and is favorably completed before the operation (12-2) to be described below. The processing does not have to be completed before the operation of (12-2) to be described below.

The server device 202 may output, to the service provider, the type of the short attribute, the type of each attribute of the priority attribute pair, and the type of the credibility addable attribute in a distinguishable manner based on the preparation request message, for example. The server device 202 acquires the value of the short attribute, the value of each attribute of the priority attribute pair, the value of the credibility addable attribute, and the like based on the operation input of the service provider, for example. The service provider has a predetermined issuer issue VC and inputs the VC to the server device 202, for example. The service provider may collect reputation information on social media and input the reputation information to the server device 202, for example.

Thereby, the server device 202 can enable the service provider to grasp which attribute value should be preferentially prepared among the attribute values of the first attribute group. The server device 202 can enable the service provider to easily and efficiently prepare the value of the short attribute, the value of each attribute of the priority attribute pair, the value of the credibility addable attribute, and the like.

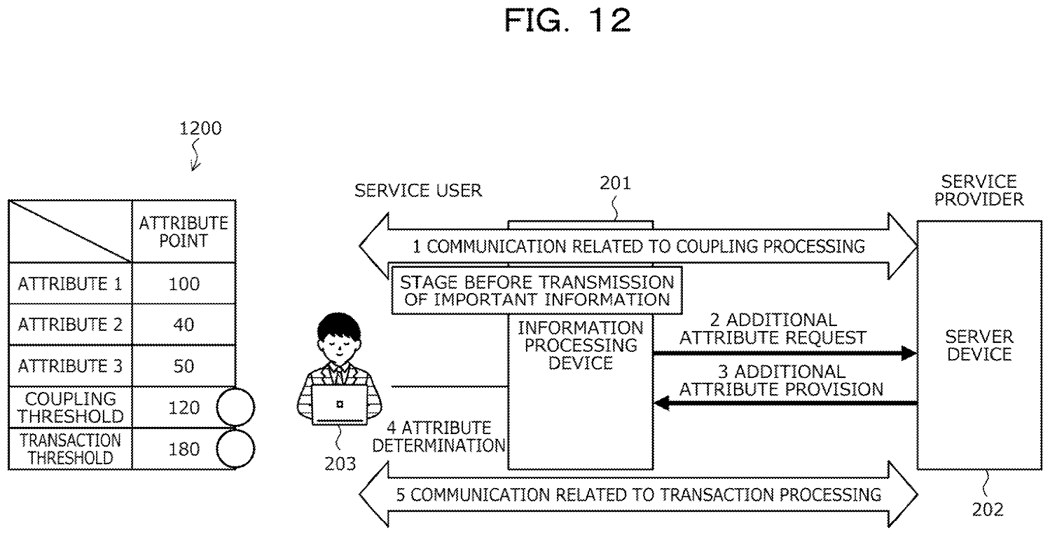

The server device 202 can improve a probability of allowing the service provider not to prepare all the attribute values of the first attribute group. The server device 202 can enable the service provider to easily avoid preparing the attribute values that the service provider does not desire to disclose for security reasons. The server device 202 can reduce the work load on the service provider and easily facilitate security. Next, the description will move onto FIG. 12.

In FIG. 12, (12-1) the information processing device 201 has permitted the coupling processing, and thus relays the communication regarding the coupling processing while restricting the communication regarding the transaction processing between the server device 202 and the client device 203.

The communication regarding the coupling processing is, for example, communication in which the client device 203 receives general information, goods catalog information, or the like from the server device 202, rather than subtleties information, money information, or the like, and enables the service user to browse the information.

The server device 202 is in the process of acquiring each additional attribute value during the process of communicating regarding the coupling processing, for example. Therefore, the server device 202 can prepare the additional attribute value before the client device 203 requests the server device 202 to disclose the additional attribute value. The server device 202 can facilitate quick disclosure of the additional attribute value in response to the client device 203 requesting the server device 202 to disclose the additional attribute value. The server device 202 allows the service user not to be conscious of the time for preparing the additional attribute value, thereby improving the convenience.

(12-2) After the communication with the server device 202 regarding the coupling processing, the client device 203 transmits a start request for starting the communication with the server device 202 regarding the coupling processing to the information processing device 201 based on the operation input of the service user. When having received the start request, the information processing device 201 generates the second attribute request message that requests the server device 202 to disclose each specified additional attribute value, and transmits the second attribute request message to the server device 202.

(12-3) The server device 202 receives the second attribute request message. When having received the second attribute request message, the server device 202 generates a second attribute provision message including the attribute information indicating each additional attribute value and the credibility information regarding the additional attribute value, and transmits the second attribute provision message to the information processing device 201. Thereby, the server device 202 has already started the processing of acquiring the additional attribute value, and thus can reduce a response time of the second attribute provision message to the second attribute request message.

In the example of FIG. 12, the server device 202 has already acquired the additional attribute value “electronic corporate registration” of the “organization name”, the additional attribute value “industry group authentication” of the “shipment record”, and the like, for example. Therefore, the server device 202 generates the second attribute provision message including, for example, the additional attribute value “electronic corporate registration” of the “organization name”, the additional attribute value “industry group announcement” of the “shipment record”, and the like, and transmits the second attribute provision message to the information processing device 201.

(12-4) The information processing device 201 refers to the level information management table 500, and integrates the attribute value indicated by the first attribute provision message and the additional attribute value indicated by the second attribute provision message to generate an attribute value list. The information processing device 201 inserts, for example, any type of first attribute value indicated only by the first attribute provision message into the attribute value list. The information processing device 201 inserts, for example, any type of second additional attribute value indicated only by the second attribute provision message into the attribute value list. For example, in a case where the first attribute provision message and the second attribute provision message respectively indicate the attribute value and the additional attribute value of the same type, the information processing device 201 selects and inserts the additional attribute value into the attribute value list.

The information processing device 201 determines, based on each attribute value included in the attribute value list and the credibility information regarding the attribute value, the attribute level of the attribute. The information processing device 201 determines, based on each additional attribute value included in the attribute value list and the credibility information regarding the additional attribute value, the attribute level of the additional attribute.

The information processing device 201 refers to the level information management table 500 illustrated in FIG. 10, and determines that the combination of the value “priority nationality” of the “nationality” and the credibility information “certificate of public institution” regarding the attribute value is the attribute level “3”. The information processing device 201 refers to the level information management table 500 illustrated in FIG. 10, and determines that the value “electronic corporate registration” of the “organization name” is the attribute level “2”. The information processing device 201 refers to the level information management table 500 and determines that the value “industry group announcement (not illustrated)” of the “shipment record” is the attribute level “2”.

The information processing device 201 refers to the attribute-related information management table 400 illustrated in FIG. 9, and determines the attribute point corresponding to the determined attribute level of each attribute. The information processing device 201 refers to the attribute-related information management table 400 illustrated in FIG. 9 and determines that the attribute point corresponding to the attribute level “3” of the “nationality” is “100”. The information processing device 201 refers to the attribute-related information management table 400 illustrated in FIG. 9 and determines that the attribute point corresponding to the attribute level “2” of the “organization name” is “40”. The information processing device 201 refers to the attribute-related information management table 400 illustrated in FIG. 9 and determines that the attribute point corresponding to the attribute level “2” of the “shipment record” is “50”

The information processing device 201 calculates the total point obtained by adding the determined attribute points. The information processing device 201 calculates the total point “190”. The information processing device 201 refers to the attribute-related information management table 400 illustrated in FIG. 9, and acquires the transaction threshold “180”. The information processing device 201 determines whether or not to perform the transaction processing again based on whether or not the calculated total point the transaction threshold.

In the case of the total point the transaction threshold, the information processing device 201 evaluates that the reliability of the server device 202 is relatively high, and determines to perform the coupling processing and transaction processing. The information processing device 201 permits the server device 202 and the client device 203 to perform the transaction processing, and sets them to be able to communicate without restrictions. Thereby, when evaluating that the reliability of the server device 202 is relatively high, the information processing device 201 can enable the server device 202 and the client device 203 to communicate without restrictions.

In the example of FIG. 12, the information processing device 201 has determined the attribute points as illustrated in table 1200 and has acquired the coupling threshold and the transaction threshold, and thus determines the total point of 190 the transaction threshold of 180. Therefore, the transaction processing is permitted and no restrictions on the communication is set for the server device 202 and the client device 203.

(12-5) The information processing device 201 has permitted the transaction processing, and thus relays the communication regarding the transaction processing between the server device 202 and the client device 203. The communication regarding the transaction processing is, for example, communication in which the client device 203 transmits or receives important information such as subtleties information, money information, or the like to or from the server device 202, and the service user purchases the goods.

Thereby, the information processing device 201 can control the communication between the server device 202 and the client device 203 so that the service user is not conscious of the restrictions on the communication between the server device 202 and the client device 203. The information processing device 201 can improve the convenience for the service user.

Furthermore, the information processing device 201 can secure the grace time for the service provider to prepare the additional attribute value and improve the reliability of the server device 202. The information processing device 201 can evaluate the reliability of the server device 202 in stages according to changes in content of the communication between the server device 202 and the client device 203.

Therefore, the information processing device 201 can avoid a situation in which the service user gives up communication with the service provider due to the reliability of the server device 202. Therefore, the information processing device 201 can activate communication between the server device 202 and the client device 203, and can activate online economic activities, creative activities, or the like.

The information processing device 201 makes available a combination of a plurality of attributes that is useful when evaluating the reliability of the server device 202 based on the importance and credibility of the attributes according to the purpose of using the service. Therefore, the information processing device 201 can accurately evaluate the reliability of the server device 202 according to the intention of the service user.

Here, the case in which the information processing device 201 evaluates the reliability of the server device 202 in stages according to the two types of communication regarding coupling and transaction between the server device 202 and the client device 203 has been described, but the present embodiment is not limited to this. For example, the information processing device 201 may evaluate the reliability of the server device 202 in stages according to three or more types of communication between the server device 202 and the client device 203. In this case, the attribute-related information management table 400 stores three or more stepwise thresholds.

(Determination Processing Procedure)

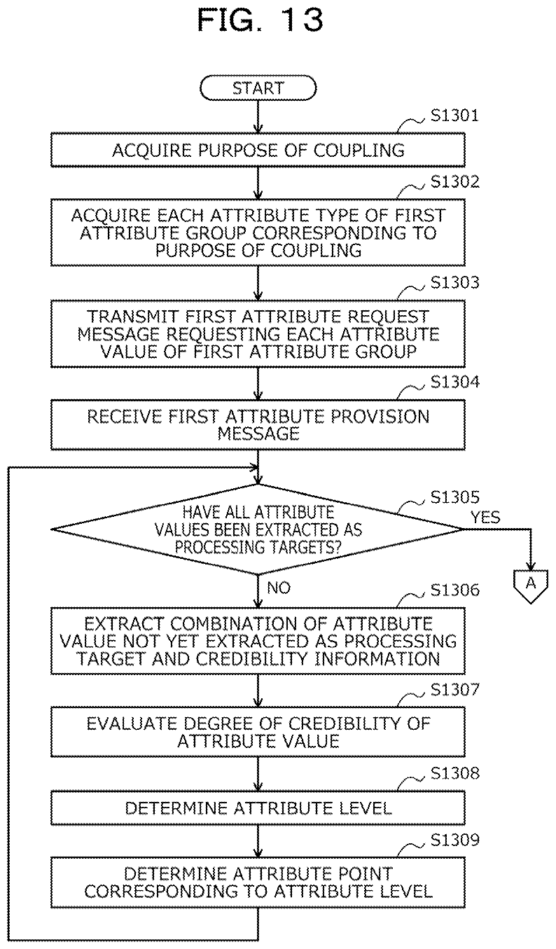

Next, an example of a determination processing procedure executed by the information processing device 201 will be described with reference to FIGS. 13 to 16. The determination processing is implemented by, for example, the CPU 301, a storage area such as the memory 302 or the recording medium 305, and the network I/F 303 illustrated in FIG. 3.

FIGS. 13 to 16 are flowcharts illustrating an example of the determination processing procedure. In FIG. 13, the information processing device 201 acquires the purpose of coupling (step S1301).

Next, the information processing device 201 refers to the attribute-related information management table 400 and acquires each attribute type of the first attribute group corresponding to the acquired purpose of coupling (step S1302). Then, the information processing device 201 transmits the first attribute request message that requests each attribute value of the first attribute group based on the acquired each attribute type of the first attribute group to the server device 202 (step S1303).

Next, the information processing device 201 receives the first attribute provision message that indicates a combination of each attribute value included in one or more attributes of the first attribute group and the credibility information regarding the attribute value from the server device 202 (step S1304).

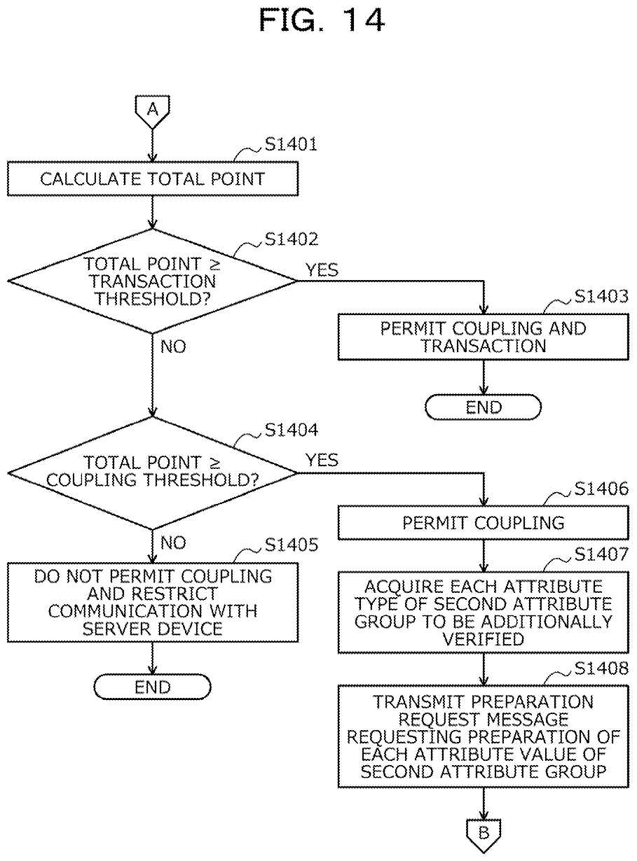

Then, the information processing device 201 determines whether or not all the attribute values included in the one or more attributes indicated by the first attribute provision message have been extracted as processing targets (step S1305). Here, in the case where all the attribute values have been extracted (step S1305: Yes), the information processing device 201 proceeds to the processing of step S1401 in FIG. 14. On the other hand, in the case where there is an unextracted attribute value (step S1305: No), the information processing device 201 proceeds to the processing of step S1306.

In step S1306, the information processing device 201 extracts a combination of the attribute value not yet extracted as the processing target among the attribute values included in the one or more attributes indicated by the first attribute provision message, and the credibility information (step S1306).

Next, the information processing device 201 evaluates the degree of credibility of the extracted attribute value based on the credibility information (step S1307). Then, the information processing device 201 refers to the level information management table 500 and determines the attribute level based on the combination of the extracted attribute value and the evaluated degree of credibility (step S1308).

Next, the information processing device 201 refers to the attribute-related information management table 400, and determines the attribute point corresponding to the determined attribute level (step S1309). Then, the information processing device 201 returns to the processing of step S1305. Here, the description moves onto FIG. 14.

In FIG. 14, the information processing device 201 calculates the total point obtained by adding the determined attribute points (step S1401).

Next, the information processing device 201 determines whether or not the calculated total point the transaction threshold (step S1402). Here, in the case where the total point the transaction threshold does not hold (step S1402: No), the information processing device 201 proceeds to the processing of step S1404. On the other hand, in the case where the total point the transaction threshold holds (step S1402: Yes), the information processing device 201 proceeds to the processing of step S1403.

In step S1403, the information processing device 201 permits the coupling and transaction, and sets no restrictions on the communication with the server device 202 (step S1403). Then, the information processing device 201 terminates the determination processing.

In step S1404, the information processing device 201 determines whether or not the calculated total point the coupling threshold (step S1404). Here, in the case where the total point the coupling threshold does not hold (step S1404: No), the information processing device 201 proceeds to the processing of step S1405. On the other hand, in the case where the total point the coupling threshold holds (step S1404: Yes), the information processing device 201 proceeds to the processing of step S1406.

In step S1405, the information processing device 201 does not permit the coupling, and restricts the communication with the server device 202 (step S1405). Then, the information processing device 201 terminates the determination processing.

In step S1406, the information processing device 201 permits the coupling (step S1406). Next, the information processing device 201 refers to the attribute-related information management table 400, and acquires each attribute type of the second attribute group to be additionally verified based on each attribute value included in the one or more attributes indicated by the first attribute provision message (step S1407).

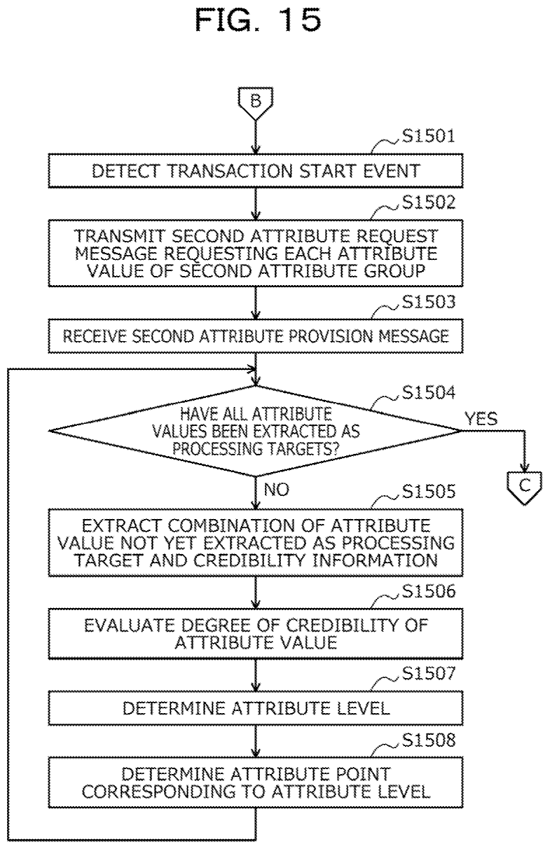

Then, the information processing device 201 transmits the preparation request message that requests preparation of each attribute value of the second attribute group based on the acquired each attribute type of the second attribute group to the server device 202 (step S1408). Thereafter, the information processing device 201 proceeds to processing of step S1501 of FIG. Here, the description moves onto FIG. 15.

In FIG. 15, the information processing device 201 detects a transaction start event (step S1501). Next, the information processing device 201 transmits, to the server device 202, the second attribute request message that requests each attribute value of the second attribute group (step S1502).

Then, the information processing device 201 receives the second attribute provision message that indicates a combination of each attribute value included in one or more attributes of the second attribute group and the credibility information regarding the attribute value from the server device 202 (step S1503).

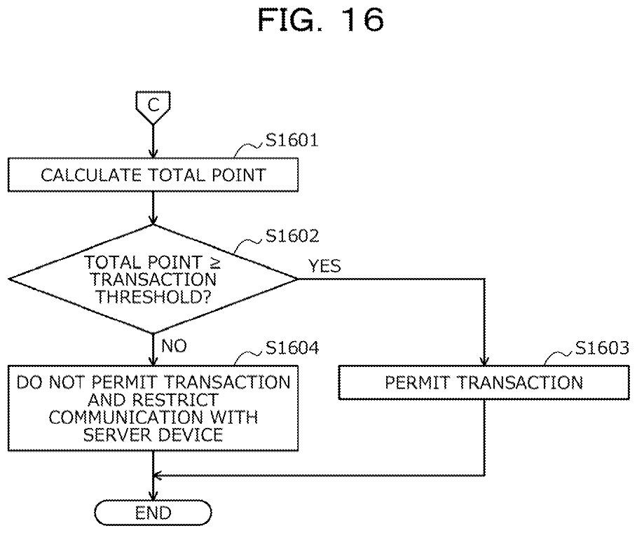

Next, the information processing device 201 determines whether or not all the attribute values included in the one or more attributes indicated by the second attribute provision message have been extracted as processing targets (step S1504). Here, in the case where all the attribute values have been extracted (step S1504: Yes), the information processing device 201 proceeds to the processing of step S1601 in FIG. 16. On the other hand, in the case where there is an unextracted attribute value (step S1504: No), the information processing device 201 proceeds to the processing of step S1505.

In step S1505, the information processing device 201 extracts a combination of the attribute value not yet extracted as the processing target among the attribute values included in the one or more attributes indicated by the second attribute provision message, and the credibility information (step S1505).

Next, the information processing device 201 evaluates the degree of credibility of the extracted attribute value based on the credibility information (step S1506). Then, the information processing device 201 refers to the level information management table 500 and determines the attribute level based on the combination of the extracted attribute value and the evaluated degree of credibility (step S1507).

Next, the information processing device 201 refers to the attribute-related information management table 400, and determines the attribute point corresponding to the determined attribute level (step S1508). Then, the information processing device 201 returns to the processing of step S1504. Here, description will be moved onto FIG. 16.

In FIG. 16, the information processing device 201 calculates the total point obtained by adding the attribute points determined in steps S1309 and S1508 (step S1601).

Next, the information processing device 201 determines whether or not the calculated total point the transaction threshold (step S1602). Here, in the case where the total point the transaction threshold holds (step S1602: Yes), the information processing device 201 proceeds to the processing of step S1603. On the other hand, in the case where the total point the transaction threshold does not hold (step S1602: No), the information processing device 201 proceeds to the processing of step S1604.

In step S1603, the information processing device 201 permits the transaction, and sets no restrictions on the communication with the server device 202 (step S1603). Then, the information processing device 201 terminates the determination processing.

In step S1604, the information processing device 201 does not permit the transaction, and restricts the communication with the server device 202 (step S1604). Then, the information processing device 201 terminates the determination processing. Thereby, the information processing device 201 can properly evaluate the reliability of the server device 202 and accurately determine whether or not to permit the coupling and transaction.

Here, the information processing device 201 may switch some steps in each of the flowcharts in FIGS. 13 to 16 in the processing order and execute the processing. For example, the processing in steps S1402 and S1403 and the processing in steps S1404 and S1405 may be switched in the order.

Furthermore, the information processing device 201 may omit processing of some steps in each of the flowcharts in FIGS. 13 to 16.

As described above, according to the information processing device 201, it is possible to specify the first attribute group corresponding to the type of the target procedure to be performed for the second device 102 by referring to the storage unit that stores the attribute group related to the second device 102 in association with each type of the procedure. According to the information processing device 201, it is possible to transmit the transmission request of each attribute value of the specified first attribute group to the second device 102. According to the information processing device 201, it is possible to determine whether or not to perform the target procedure based on each attribute value of the one or more attributes included in the first attribute group received from the second device 102 in response to the transmission request. Thereby, the information processing device 201 can use different values of attributes to refer to according to the type of the target procedure, can accurately evaluate the reliability of the second device 102, and can accurately determine whether or not to perform the target procedure. Furthermore, the information processing device 201 can reduce the processing load and the processing time taken when determining whether or not to perform the target procedure.

According to the information processing device 201, it is possible to store the information that enables specification of the score indicating the reliability of the second device 102 corresponding to the attribute value for each attribute of the second device 102. According to the information processing device 201, it is possible to specify the score indicating the reliability related to the second device 102, the score corresponding to each attribute value of the one or more attributes included in the first attribute group received from the second device 102 in response to the transmission request based on the stored information. According to the information processing device 201, it is possible to determine whether or not to perform the target procedure based on the total score obtained by adding the specified scores. Thereby, the information processing device 201 can convert attribute values on different scales into score values on the same scale, and can accurately determine whether or not to perform the target procedure.

According to the information processing device 201, it is possible to transmit the first transmission request of each attribute value of the specified first attribute group to the second device 102. According to the information processing device 201, it is possible to determine whether or not to perform at least the first processing based on each attribute value of the one or more attributes included in the first attribute group received from the second device 102 in response to the first transmission request. According to the information processing device 201, it is possible to specify the second attribute group related to the second device 102 based on each attribute value of the one or more attributes included in the first attribute group received from the second device 102 in response to the first transmission request in the case of determining to perform the first processing. According to the information processing device 201, it is possible to transmit the second transmission request of each attribute value of the specified second attribute group to the second device 102. According to the information processing device 201, it is possible to determine whether or not to perform the second processing based on each attribute value of the one or more attributes included in the second attribute group received from the second device 102 in response to the second transmission request. Thereby, the information processing device 201 can evaluate the reliability of the second device 102 in stages, and can perform the target procedure in stages. Therefore, the information processing device 201 can efficiently implement the target procedure.

According to the information processing device 201, it is possible to determine whether or not to perform the first processing and whether or not to perform the second processing based on each attribute value of the one or more attributes included in the first attribute group received from the second device 102 in response to the first transmission request. According to the information processing device 201, it is possible to specify the second attribute group based on each attribute value of the one or more attributes included in the first attribute group received from the second device 102 in response to the first transmission request in the case of determining to perform the first processing but not to perform the second processing. According to the information processing device 201, it is possible to transmit the second transmission request of each attribute value of the specified second attribute group to the second device 102. According to the information processing device 201, it is possible to determine again whether or not to perform the second processing based on each attribute value of the one or more attributes included in the second attribute group received from the second device 102 in response to the second transmission request. Thereby, the information processing device 201 can avoid transmitting the second transmission request to the second device 102 by determining to perform the second processing, and can reduce the processing load between the local device and the second device 102.

According to the information processing device 201, it is possible to specify the first score indicating the reliability related to the second device 102, the first score corresponding to each attribute value of the one or more attributes included in the first attribute group received from the second device 102 in response to the first transmission request based on the stored information. According to the information processing device 201, it is possible to determine to perform the first processing in the case where the first total score obtained by adding the specified first scores is equal to or greater than the first reference score, and determine not to perform the first processing in the case where the first total score is less than the first reference score. According to the information processing device 201, it is possible to determine to perform the second processing in the case where the second total score is equal to or greater than the second reference score that is greater in value than the first reference score, and determine not to perform the second processing in the case where the second total score is less than the second reference score. Thereby, the information processing device 201 can convert attribute values on different scales into score values on the same scale, and can accurately determine whether or not to perform the first processing and the second processing.

According to the information processing device 201, it is possible to specify the second attribute group related to the second device 102 based on the shortfall by which the first total score falls short of the second reference score in the case of determining to perform the first processing but not to perform the second processing. Thereby, the information processing device 201 can specify the second attribute group useful in determining whether or not to perform the second processing again, can easily determine to perform the second processing, and can improve the convenience.

According to the information processing device 201, it is possible to start the first processing and to transmit the second transmission request of each attribute value of the specified second attribute group to the second device 102 before completing the first processing, in the case of determining to perform the first processing. Thereby, the information processing device 201 can prepare the attribute values of the second attribute group in the second device 102 in advance before determining whether or not to perform the second processing, and can make the target procedure efficient.

According to the information processing device 201, it is possible to accept the input of the combination of the type of procedure and the first attribute group related to the second device 102. According to the information processing device 201, it is possible to update the content stored in the storage unit based on the accepted combination. Thereby, the information processing device 201 can reflect the input in the content stored in the storage unit, and can accurately determine whether or not to perform the target procedure in line with the intent of the parties involved in the target procedure.

According to the information processing device 201, it is possible to accept designation of the type of the target procedure. According to the information processing device 201, it is possible to refer to the storage unit and specify the first attribute group corresponding to the designated type of the target procedure. Thereby, the information processing device 201 can allow the parties involved in the target procedure to specify the type of the target procedure, and can set the target procedure according to the intention of the parties.

According to the information processing device 201, it is possible to specify the type of the target procedure based on the address of the second device 102. Thereby, the information processing device 201 allows the parties involved in the target procedure to avoid specifying the type of the target procedure, and can reduce the work load on the parties.

According to the information processing device 201, it is possible to output the alert indicating that the target procedure is not to be performed in the case of determining not to perform the target procedure. Thereby, the information processing device 201 can notify the parties involved in the target procedure that the reliability of the second device 102 is relatively low, and can reduce the risks for the parties.

According to the information processing device 201, it is possible to output the first alert indicating that the first processing is not to be performed in the case of determining not to perform the first processing. According to the information processing device 201, it is possible to output the second alert indicating that the second processing is not to be performed in the case of determining not to perform the second processing. Thereby, the information processing device 201 can notify the parties involved in the target procedure that the reliability of the second device 102 is relatively low, and can reduce the risks for the parties.

According to the information processing device 201, it is possible to specify the second attribute group related to the second device 102 from the first attribute group based on each attribute value of the one or more attributes included in the first attribute group received from the second device 102 in response to the first transmission request in the case of determining to perform the first processing. Thereby, the information processing device 201 can make the attribute value once requested to the second device 102 requestable again.

According to the information processing device 201, it is possible to transmit the transmission request of each attribute value of the first attribute group related to the second device 102 to the second device 102. According to the information processing device 201, it is possible to determine whether or not to perform at least the first processing, which is performed for the second device 102, based on each attribute value of the one or more attributes included in the first attribute group received from the second device 102 in response to the first transmission request. According to the information processing device 201, it is possible to specify the second attribute group related to the second device 102 based on each attribute value of the one or more attributes included in the first attribute group received from the second device 102 in response to the first transmission request in the case of determining to perform the first processing. According to the information processing device 201, it is possible to transmit the second transmission request of each attribute value of the specified second attribute group to the second device 102. According to the information processing device 201, it is possible to determine whether or not to perform the second processing, which is performed for the second device 102 after the first processing, based on each attribute value of the one or more attributes included in the second attribute group received from the second device 102 in response to the second transmission request. Thereby, the information processing device 201 can evaluate the reliability of the second device 102 in stages, and can perform the target procedure in stages. Therefore, the information processing device 201 can efficiently implement the target procedure.

Note that the information processing method described in the present embodiment may be implemented by executing a program prepared in advance on a computer such as a PC or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like.

Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a first device including a first processor; and
a second device including a second processor communicable with the first device, wherein
the first processor
refers to a memory that stores an attribute group related to the second device in association with each type of a procedure, and specifies a first attribute group corresponding to a type of a target procedure to be performed for the second device,
transmits a transmission request of each attribute value of the specified first attribute group to the second device, and
determines whether or not to perform the target procedure based on the each attribute value of one or more attributes included in the first attribute group received from the second device in response to the transmission request.

2. The information processing system according to claim 1, wherein
the first processor
specifies, for each attribute related to the second device, based on information that enables specification of a score that indicates reliability related to the second device and corresponds to a value of the attribute, the score that indicates the reliability related to the second device and corresponds to the each attribute value of the one or more attributes included in the first attribute group received from the second device in response to the transmission request, and
determines whether or not to perform the target procedure based on a total score obtained by adding the specified scores.

3. The information processing system according to claim 2, wherein
the target procedure includes first processing performed for the second device and second processing performed for the second device after the first processing, and
the first processor
transmits a first transmission request of the each attribute value of the specified first attribute group to the second device,
determines whether or not to perform at least the first processing based on the each attribute value of the one or more attributes included in the first attribute group received from the second device in response to the first transmission request,
specifies a second attribute group related to the second device based on the each attribute value of the one or more attributes included in the first attribute group received from the second device in response to the first transmission request, in a case of determining to perform the first processing,
transmits a second transmission request of each attribute value of the specified second attribute group to the second device, and
determines whether or not to perform the second processing based on each attribute value of one or more attributes included in the second attribute group received from the second device in response to the second transmission request.

4. The information processing system according to claim 3, wherein
the first processor
determines whether or not to perform the first processing and whether or not to perform the second processing based on the each attribute value of the one or more attributes included in the first attribute group received from the second device in response to the first transmission request,
specifies a second attribute group related to the second device based on the each attribute value of the one or more attributes included in the first attribute group received from the second device in response to the first transmission request, in a case of determining to perform the first processing but determining not to perform the second processing,
transmits the second transmission request of the each attribute value of the specified second attribute group to the second device, and
determines whether or not to perform the second processing again based on the each attribute value of the one or more attributes included in the second attribute group received from the second device in response to the second transmission request.

5. The information processing system according to claim 4, wherein
the first processor
specifies a first score that indicates reliability related to the second device and corresponds to the each attribute value of the one or more attributes included in the first attribute group received from the second device in response to the first transmission request based on the information, and
determines to perform the first processing in a case where a first total score obtained by adding the specified first scores is equal to or greater than a first reference score, determines not to perform the first processing in a case where the first total score is less than the first reference score, moreover, determines to perform the second processing in a case where the first total score is equal to or greater than a second reference score greater in value than the first reference score, and determines not to perform the second processing in a case where the first total score is less than the second reference score.

6. The information processing system according to claim 5, wherein
the first processor
specifies the second attribute group related to the second device based on a shortfall by which the first total score falls short of the second reference score in the case of determining to perform the first processing but not to perform the second processing.

7. The information processing system according to claim 3, wherein
the first processor
starts the first processing and transmits the second transmission request of the each attribute value of the specified second attribute group to the second device before completing the first processing in the case of determining to perform the first processing.

8. The information processing system according to claim 3, wherein
the first processor
accepts an input of a combination of the type of a procedure and the first attribute group related to the second device, and
updates content stored in the memory based on the accepted combination.

9. The information processing system according to claim 3, wherein
the first processor
accepts designation of the type of the target procedure, and
refers to the memory and specifies the first attribute group corresponding to the designated type of the target procedure.

10. The information processing system according to claim 3, wherein
the first processor
specifies the type of the target procedure based on an address of the second device.

11. The information processing system according to claim 1, wherein
the first processor
outputs an alert that indicates that the target procedure is not to be performed in the case of determining not to perform the target procedure.

12. The information processing system according to claim 3, wherein
the first processor
outputs a first alert that indicates that the first processing is not to be performed in the case of determining not to perform the first processing, and
outputs a second alert that indicates that the second processing is not to be performed in the case of determining not to perform the second processing.

13. The information processing system according to claim 3, wherein
the first processor
specifies the second attribute group related to the second device from the first attribute group based on the each attribute value of the one or more attributes included in the first attribute group received from the second device in response to the first transmission request in the case of determining to perform the first processing.

14. An information processing device comprising:
a memory; and
a processor coupled to the memory and configured to;
communicate with another device;
refer to the memory that stores an attribute group related to the another device in association with each type of a procedure;
specify a first attribute group corresponding to a type of a target procedure to be performed for the another device;
transmit a transmission request of each attribute value of the specified first attribute group to the another device; and
determine whether or not to perform the target procedure based on the each attribute value of one or more attributes included in the first attribute group received from the another device in response to the transmission request.

15. An information processing system comprising:
a first device including a first processor; and
a second device including a second processor and communicable with the first device, wherein
the first processor
transmits a first transmission request of each attribute value of a first attribute group related to the second device to the second device,
determines whether or not to perform at least first processing that is performed for the second device based on each attribute value of one or more attributes included in the first attribute group received from the second device in response to the first transmission request,
specifies a second attribute group related to the second device based on the each attribute value of the one or more attributes included in the first attribute group received from the second device in response to the first transmission request, in a case of determining to perform the first processing,
transmits a second transmission request of each attribute value of the specified second attribute group to the second device, and
determines whether or not to perform second processing that is performed for the second device after the first processing based on each attribute value of one or more attributes included in the second attribute group received from the second device in response to the second transmission request.
